(19) United States
(12) Patent Application Publication
(10) Pub. No.: US 2003/0005052 A1
(43) Pub. Date: Jan. 2, 2003

(54) Networked broadcasting system with provision for the addition of advertisements or messages

(76) Inventors: Norman Feuer, La Jolla, CA (US); Mike Ray Williams, Auburn, GA (US); Michael A. Elliott, Lincoln, NE (US); John Robert Hilsman, Conyers, GA (US); Kevin Brian Moore, Brentwood, TN (US); Philip George Printz, San Diego, CA (US); Paul Aaron, Lincoln, NE (US)

Correspondence Address: FOLEY & LARDNER, 330 NORTH WABASH AVENUE, SUITE 3300, CHICAGO, IL, 60611-3608, US

(21) Appl. No.: 09/872,317

(22) Filed: Jun. 1, 2001

(51) Int. Cl. G06F 15/16

(52) U.S. Cl. 709/204; 709/217

(57) ABSTRACT

An Internet based broadcasting system manages the insertion of advertisements and other messages into multiple broadcasts of live sporting events and other types of broadcasts. The insertion of advertisements and other messages is governed by program logs generated by a traffic system, signals extracted from the broadcasts themselves, and signals received from producer systems. The traffic system facilitates the marketing of advertising opportunities for the multiple broadcasts packaged in a variety of ways. The broadcasts are received by tuner systems that are automatically downloaded and installed on user's computers. The tuner systems can download and display demographically selected multimedia advertisements, banner advertisements, and a variety of messages that may be called for by the producer systems, which may be wireless portable computers that can be carried to sports events or other broadcasts by the producers of the broadcasts.

### CROSS-REFERENCE TO RELATED APPLICATIONS

Not applicable.

### STATEMENT RE FEDERALLY SPONSORED RESEARCH OR DEVELOPMENT

Not applicable.

### BACKGROUND OF THE INVENTION

1. Field of the Invention

This invention relates generally to audio broadcasting over the Internet, and in particular, it relates to the broadcasting of live as well as recorded events including advertising in situations where it is desirable to target the selection of multimedia advertising to the demographics of the audience.

2. Brief Description of the Prior Art

Streaming media technology has advanced to the point where both live and prerecorded audio and video broadcasts are routinely made over the Internet. On the receiving end, software such as Real Audio Player and Windows Media Player receive and buffer such incoming broadcasts and then decode them and play them over speakers. These programs also can download and display animated images and web pages and can present low resolution movies encoded using MPEG1 technology. The user of such a system may select from a menu of sources of information and have not only the audio but also the video and hypertext menus retrieved and displayed at a rate of delivery commensurate with the available bandwidth between the source of the information and target computer.

Many such services are offered free of charge, with some advertising. For example, thirty seconds of advertising in audio and/or video may proceed the beginning of a live broadcast of a radio station or the like. U.S. Pat. No. 5,931,901 permits a user to select formats of music to be downloaded, and then overlays on the music soundtrack advertisements chosen in accordance with demographics derived from the user's selection of musical material.

The technology also exists to display Internet banner ads in windows during a broadcast, permitting the user to view and to click on the banner advertisements and then to be led directly to the website of the sponsor.

Prior art systems generally charge advertisers in terms of so many dollars per one thousand impressions, where an impression is a banner ad display or some other single contact. Such systems are not specific as to the time when an ad is displayed, and the content of the material that an individual may otherwise be browsing. In addition, to the extent that advertisements are demographically based and selected, there is a threat to the privacy of the individual in that these demographic materials are typically gathered, centrally stored, and then used to control the selection of the advertisements displayed. Individuals are reluctant to submit personal information which they know is going to be stored centrally and which they fear might later be sold and used in undesirable ways.

Advertisers generally prefer to buy avails, where an avail is an ad that runs at a known time in conjunction with material having a known content. Advertisers also prefer to have their ads displayed to individuals about whom preferably there is some knowledge of demographics.

Radio stations, in general, have difficulty marketing avails because each station, at a given time, can only market an avail for one event, whereas there may be hundreds of other competing events or programs running at the same time. It would be desirable from the point of view of advertisers to be able to purchase avails in larger quantities, such as for all the big twelve football games running on a given Saturday, rather than for only one team. And when purchasing advertising opportunities, a given advertiser might wish to have different advertising supplied to individuals of different ages or living in different geographic locations, if that can be arranged.

Another difficulty faced by prior arrangements is that of providing high quality, multimedia advertising along with live material, when it is difficult to predict in advance precisely when advertisements may need to be inserted into the broadcast stream without interfering with such things as an ongoing football game or other sports event. Ideally, the timing of advertisements must be precisely queued in real time with very little advance warning of when a given ad may be run.

Accordingly, it is a primary object of the present invention to overcome these as well as other deficiencies of known prior art arrangements and to achieve both real-time and also prerecorded Internet broadcasting with precisely coordinated advertising done in a way that preserves individual privacy yet facilitates the flexible marketing of avail to advertisers.

### BRIEF SUMMARY OF THE INVENTION

Briefly summarized, and in accordance with these and other objects, the present invention can be found embodied within an Internet sports broadcasting system that broadcasts multiple live sports events or radio programming over the Internet to tuners installed on listener's PCs which are designed to display banner ads, scores, scrolling messages, short interactive moves relating to the content or play, and advertisements superimposed over those of the live broadcast and, optionally, enhanced with “rich” or multimedia advertisements which are optionally varied in accordance with user demographics that are kept private by being maintained on the individual user's machine, rather than in a centralized database.

Multiple satellite receivers can be used to download, or land data lines can be used to and pass live broadcasts of games or radio programming to insert and coordinating servers where, in response to tones encoded in the live broadcasts, audio ads are automatically inserted by the server, and the broadcast is passed to the Internet after processing by a stream encoder and wrapper server and by a stream server.

A producer's system, possibly a mobile computer operated by a producer who views each game or program, sends commands and messages, including score messages, messages for the scroller, and commands to display play-related animated graphics to the insert and coordinating server where these commands are digitally encoded and are fed to the stream encoder and wrapper where they are combined as digital messages to the audio stream and broadcast over the Internet.

In addition, a traffic system creates and passes to the insert and coordinating server information that enables audio advertisements to be selected and inserted and that also inserts pre-queue commands for any rich media advertisements into the audio data stream so that well prior to their time of presentation multimedia ads are downloaded from a rich ad server into individual tuners at listener's sites so that the moment a break occurs in the broadcast program or sports event, these ads may be played back in windows on the listener's PC.

The pre-queue commands cause the individual PCs to request the rich media ads from the rich ad server, and logic is provided to ensure that the downloading of those ads not interfere with the real-time reception of the audio broadcast. Demographic information concerning the listeners, gathered to and maintained only on the listener's PC, is uploaded without listener identification to the rich ad server so that the downloaded ads may be tailored demographically to the particular listener without revealing the listener's identity or centrally storing the listener's demographics.

Further objects and advantages of the invention are apparent in the detailed description which follows, and the features of novelty which characterize the invention are set forth in the claims annexed to and forming a part of this specification.

### BRIEF DESCRIPTION OF THE SEVERAL VIEWS OF THE DRAWINGS

For a better understanding of the invention, reference will be made to the drawings, wherein:

FIG. 1 presents an overview block diagram of an Internet sports broadcasting system designed in accordance with the principles of the present invention;

FIG. 2 is a block diagram of the insert/coordinating server and of its interaction with other system components;

FIG. 3 illustrates a typical log file content of the log database within the insert coordinating server shown in FIG. 2;

FIG. 4 is an overview flow diagram illustrating the actions that may be taken by the insert/coordinating server;

FIG. 5 illustrates the steps that initialize the operation of the stream encoder and wrapper shown in FIG. 1;

FIG. 6 illustrates the processing of incoming digital messages by the stream encoder and wrapper shown in FIG. 1;

FIG. 7 illustrates a hand-held producer system that may be used to generate play-related messages for digital incorporation into the audio stream by the insert/coordinating server and by the stream encoder and wrapper;

FIG. 8 is a block diagram of a traffic system that facilitates the marketing of avails, the establishment of program logs for automatic control of advertisement insertion, and the establishment of multimedia ads on a rich ad server;

FIG. 9 illustrates the database for the traffic system shown in FIG. 8;

FIG. 10 illustrates the steps needed to set up the traffic system;

FIG. 11 is a procedure used to view avails in the traffic system;

FIG. 12 presents the steps needed to enter orders for avails into the traffic system;

FIG. 13 illustrates the process of having the traffic system generate logs that can control the scheduling of ads during a broadcast;

FIG. 14 illustrates a process of viewing the confirmed logs and of making adjustments for advertisements that may not have run for one reason or another;

FIG. 15 is the billing system that generates invoices from the confirmed log files;

FIG. 16 is a performance report generator for the traffic system;

FIG. 17 illustrates the contents of data within the rich ad server, including multimedia advertisements and other information;

FIG. 18 is the system within the rich ad server that receives information from an individual tuner and that optionally downloads multimedia ads tailored to a given listener's particular demographics;

FIG. 19 illustrates the steps carried out by the ad production department as they establish the databases necessary to support a broadcast;

FIG. 20 illustrates the startup procedures used to establish a tuner on an individual's computer in response to a user indicating that they wish to listen to a live broadcast;

FIG. 21 is a continuation of FIG. 20;

FIG. 22 illustrates the procedures within the tuner that execute the digital commands incorporated into the data stream along with the live broadcast;

FIG. 23 illustrates the functioning of an active-X control for the tuner that responds to pre-queue commands by downloading multimedia advertisements, that responds to fire commands by displaying preloaded advertisements, and that display special effects in response to commands from the producer;

FIG. 24 illustrates the tuner procedures that throttle the downloading process such that the downloading of rich media advertisements does not interfere with live broadcasts;

FIG. 25 illustrates the traffic department's order entry and edit screen which is used for purchasing avails;

FIG. 26 illustrates the tuner screen image compressed to form a part of the computer's tool bar; and

FIG. 27 illustrates the tuner screen expanded to full size.

### DETAILED DESCRIPTION OF THE PREFERRED EMBODIMENT

The preferred embodiment of the present invention is an Internet based sports broadcasting system 100. This system is designed to capture from satellite transmissions many simultaneous sporting events, such as football games, basketball games, and the like and to rebroadcast the audio portions of those games over the Internet where they may be picked up by individual listeners through the use of PCs and other Internet-compatible appliances. The system also responds to sub-audio 25 Hz tones in the audio signals received, and also to commands received from a producer, by inserting advertisements into the audio broadcasts. The system also uses special software embedded within the listener's PC to download what shall be called rich ads, which are movies, that may be displayed on the listener's PC simultaneously with the audio advertisements added to the broadcast; or, if the rich ads include audio of their own, as substitute multimedia advertisements. In addition, arrangements are made whereby the particular advertisements chosen may be matched to the demographics of the user, and this is done in a way that does not violate the privacy of the user. All personal identification information is maintained only at the user's PC and is never collected centrally.

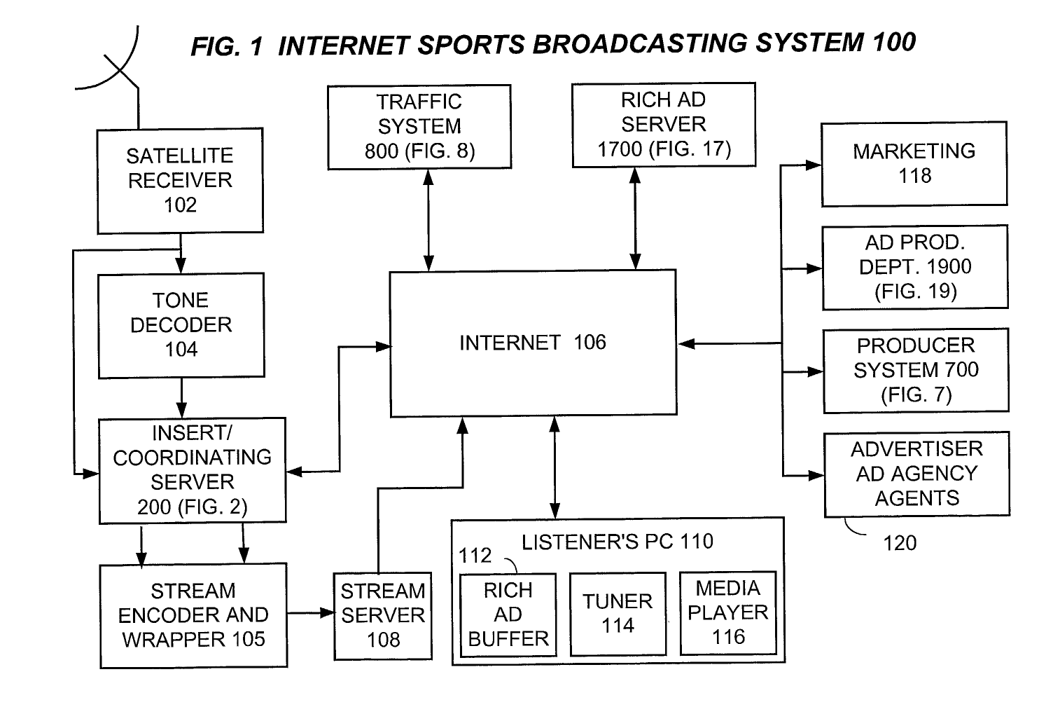

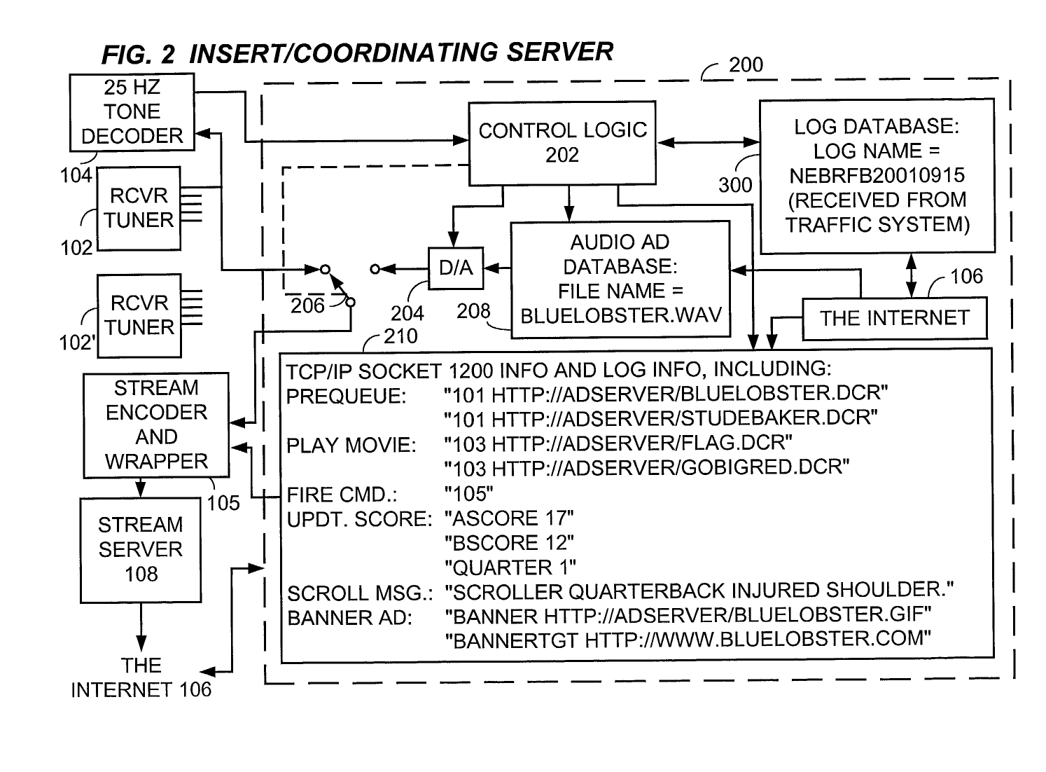

With reference to FIG. 1, a satellite receiver 102 is shown capturing one or more live broadcasts of sporting events from satellite transmissions which are designed to relay live sports broadcasts from the locations where the sporting events are taking place to local radio stations for retransmission. As is shown in FIG. 2, there may be a plurality of satellite receivers and tuners 102, 102′ (etc.) each of which is receiving a single transmission containing multiplexed audio soundtracks which a receiver and tuner separates and makes available as individual audio signals. For example, in FIG. 2, the tuner 102 is presenting five independent audio soundtracks on separate signal lines each representing the live audio broadcast of a different simultaneous sports event.

As presented by the satellite receiver and tuners 102, the audio broadcasts are simply analog monaural signals. Another embodiment of the invention might present these signals in stereo or in multichannel form and might present them with digital encoding, rather than analog encoding. Another embodiment might include digitally compressed (visual) information encoded using MPEG1, MEPG2, or the like. Embedded within these audio signals at the points where advertisements are to be inserted, as determined by the producer at the site of the broadcast, are very low frequency 25 Hz audio tones inserted to signal where an advertisement may be inserted.

With reference to FIG. 1, the audio signal for each live broadcast is passed into an insert/coordinating server 200 and also into a 25 Hz tone decoder 104. The tone decoder 104 is simply a filter device and a signal generator that detects the 25 cycle tone and that then generates a binary high/low level signal to indicate when the tone is present and when it is absent. This binary signal is fed on to the insert/coordinating server 200.

The insert/coordinating server 200 receives from the Internet 106 audio advertisements in digital form which are stored within the server 200. The server 200 also receives Internet program log files containing data defining the ordering and sequencing of advertisements and other events which are to be included within each broadcast. Using this information, as well as the tone signals presented by the tone detector 104, the insert/coordinating server is able to present to a stream encoder and wrapper 105 an analog audio signal that is normally the audio coming in from the satellite receiver 102, but that is a substituted advertisement audio signal whenever the tone decoder 104 signals that it is time for an ad to be inserted or wherever a producer system 70 signals for an advertisement. The particular advertisement inserted is determined by information in the log file for that particular broadcast, as will be explained below.

The log files also contain information concerning rich (multimedia) advertisements which may be inserted optionally by the listener's PC. Digital queues identifying this information and identifying times when they are to be preloaded into the listener's PC and times when they are to be played is sent as a second stream of digital information to the stream encoder and wrapper 105 from the insert/coordinating server 200.

Also included in this digital stream is information received from the Internet 106 that originates in the producer's system 700 that, for example, might be a hand-held pocket computer which a producer, sitting in the stands of the game, may use to send in scores, messages about game events, and commands to display various short videos to signify that a goal has been made or that some other event has occurred. All this information is passed from the producer system 700 over the Internet 106 and into the insert/coordinating server 200 which passes it on to the stream encoder and wrapper 105 for inclusion in the live broadcast.

The stream encoder and wrapper 105 is, for the most part, conventional Internet broadcasting equipment which digitizes the audio stream, compresses it, and passes it on to a stream server 108 which broadcasts it over the Internet to all of the listener's PCs 110 that are tuned into the broadcast. But in addition to conventional equipment, the stream encoder and wrapper includes additional software that takes the digital messages produced by the insert/coordinating server 200 and embeds them as digital commands included within the audio broadcast stream such that they may be recovered by the listener's PC 110.

At the listener's PC 100, the listener, who may be looking at the home web page of a particular university, will click onto a hypertext address that will automatically cause all of the necessary software to be downloaded to the listener's PC 110 to enable the initiation of reception of one of these live broadcasts. Included on the listener's PC 110 are a tuner 114 that receives a live broadcast and transforms it into audio signals which the user may listen to, that also receives various messages from the producer and displays them, and that additionally receives the rich advertisements and displays them for viewing by the listener. The tuner 114 a uses media player (Microsoft's Windows Media Player and Macromedia's Shockwave) 116 to play back the audio and multimedia material into windows on the screen of the PC. In addition, the listener's PC 110 contains a rich ad buffer 112 into which the multimedia advertisements are downloaded ahead of time from a rich ad server 1700 over the Internet 106 so that they are all loaded and ready to run in response to the digital cues which the tuner 114 receives from the media player 116 and which originate with the insert/coordinating server 200, as was just explained.

Accordingly, the normal flow is for the broadcast to flow from the satellite receiver 102, through the insert/coordinating server 200 and into the stream encoder 105, and then to flow as a digital stream out of the stream server 108, over the Internet 106, and into the media player 116 to be reproduced in the speakers of the PC 110. In addition, the insert/coordinating server 200 substitutes advertisements retrieved from its storage in response to 25-cycle tone signals received from the satellite receiver 102. In addition, prior to the times when multimedia or rich ads are to be displayed, the insert/coordinating server 200 inserts digital signals into the digital stream just described which are detected by the media player 116 and passed to the tuner 114 to cause rich media ads to be downloaded from the server 1700 into the rich ad buffer 112 prior to the time when they are to be broadcast. The process of downloading these ads is carefully regulated so that this additional flow of information does not interfere in any way with the ongoing audio broadcast. Then, at the time that an ad is normally to be inserted, the digital triggering signal for that ad is inserted by the insert/coordinating server 200 and is picked up by the media player. This signal causes the ad in multimedia form to be retrieved from the rich ad buffer 112 and to be displayed.

In addition, cues from the producer system 700 flow over the Internet 106, through the insert/coordinating server 200, into the stream encoder and wrapper 105 where they are combined into the digital stream of data, and then flow over elements 108 and 106 to the listener's PC 110 where the media player 116 again strips out these digital signals and passes them to the tuner 114 which causes appropriate information and messages and multimedia segments to be displayed.

From a business perspective, the broadcasting system 100 includes a traffic system 800 which provides mechanisms for recording well ahead of time what games will be broadcast and when, what advertising opportunities are available in those broadcasts, and what ads in the form of avails have been sold and are available for sale. The traffic system 800 is operated by a marketing staff 118 who works somewhat in the manner of the marketing staff of a radio station, except that instead of selling only the avails for a single station's log of programs, the marketing team 118 is selling collectively advertisements for numerous sporting events and is therefore able to put together very attractive marketing packets covering various types and combinations of sporting events simultaneously. These are offered to advertisers and ad agency agents 120 who may also enter the system and browse through the traffic system 800 looking at available advertising material and prices. Once an agreement is reached on the sale of avails, an ad production department 1900 works with the sponsors, advertisers, and ad agencies to download the substance of the advertisements, whether audio or multimedia, into the rich ad server 1700.

On the day of a broadcast, station logs are developed by the traffic system 800 and are downloaded into the insert/coordinating server 200 along with the audio advertisements which are to be stripped in by the server 200. All of this is done by the ad production department 1900.

Following a broadcast, the log files for the broadcast are returned by the insert/coordinating server 200 to the traffic system 800 with the addition of indicia of which ads were actually broadcast and indicia of any errors that may have occurred in those broadcasts. In this manner, a verified log of the broadcast is returned to the traffic system 800 which can then be used by administrative personnel to develop billing for advertisements that may be electronically prepared, semi-manually edited, and sent out to advertisers and ad agencies, with adjustments for ads that were not delivered being made either by reductions in price or by the substitution of other user advertising opportunities as a replacement.

Contrasting the present system with more conventional advertising systems used on the Internet, the present system differs in facilitating the purchase of avails, which are scheduled advertising slots that run at a particular times within identified program material. In addition, these avails may be purchased in sets of avails that relate to broadcasts of a similar type and quality. For example, an advertiser might simply wish to purchase advertisements relating to all of Nebraska's football games for the season, to be played during actual play, as opposed to the pre-game or post-game periods. On the other hand, an advertiser might wish to purchase ads for a particular one or two weekends to appear during the pre-game in all of the big twelve football games broadcast those weekends. The present system, by permitting similar games and games broadcast at similar times to be marketed and priced as packages creates marketing opportunities that are quite attractive to advertisers and that make it simpler to market in ways that local radio broadcasting companies cannot presently duplicate.

Conventional Internet advertising, in contrast to this, sells what are called impressions. An impression might be a banner that is displayed passively to a user, but the time when that banner is displayed and the material against which that banner is displayed may not be specifically designated. Similarly, a user might purchase “click through” advertising slots. These give little control over the time of playback, the specific nature of the material into which the ad is included, and no control over the demographics of the users. The present invention, by selling avails, is able to let the advertiser specify the time of the broadcast, the particular broadcaster class of broadcasts, and the point within the broadcast that the advertisement is presented.

The insert/coordinating server 200 is shown in FIG. 2. This server responds to audio tone signals in an incoming live audio broadcast by substituting audio advertising material for portions of the live broadcast. It also determines, by reference to broadcast log files, when various digital signal cues are to be fed into the broadcast to control the tuner on the PCs of the listener's.

The server 200 receives a live audio broadcast from a satellite receiver and tuner 102. Normally, this live audio broadcast of a sports event flows through a switch 206 to and through a stream encoder and wrapper 105 and on to a stream server 108 which applies it to the Internet 106 in the form of an Internet broadcast signal directed to listener's PCs 110. But at times that are signaled by audio tone signals within the live audio broadcast, a switch 206 can be thrown to substitute for short segments of the live broadcast audio advertisements which are retrieved from an audio ad database 208, decompressed, converted into audio by means of a digital-to-analog converter 204, and fed through the switch 206 into the audio stream.

The switch 206 is controlled by a control logic 202 within the insert/coordinating server 200. The 25 Hz audio signal from the receiver and tuner 102 is fed through a 25 Hz tone detect circuit 104 which supplies a simple binary switching signal through a parallel port adapter of the server 200 and into the control logic 202 which responds by actuating the switch 206 in accordance with instructions contained in a log file that resides in a log database 300.

The log files which control the broadcast come to the server 200 from the Internet and are stored in this log database 300. Similarly, audio files containing audio advertisements arrive from the Internet and are stored in an audio ad database 208. Other commands can come from the Internet to the control logic 202, from the producer system 700. The commands from the producer system 700, as well as digital commands from the control logic 202 that originate in log files, flow through the box 210 to the stream encoder and wrapper 105 where they are incorporated as digital information into the audio broadcast.

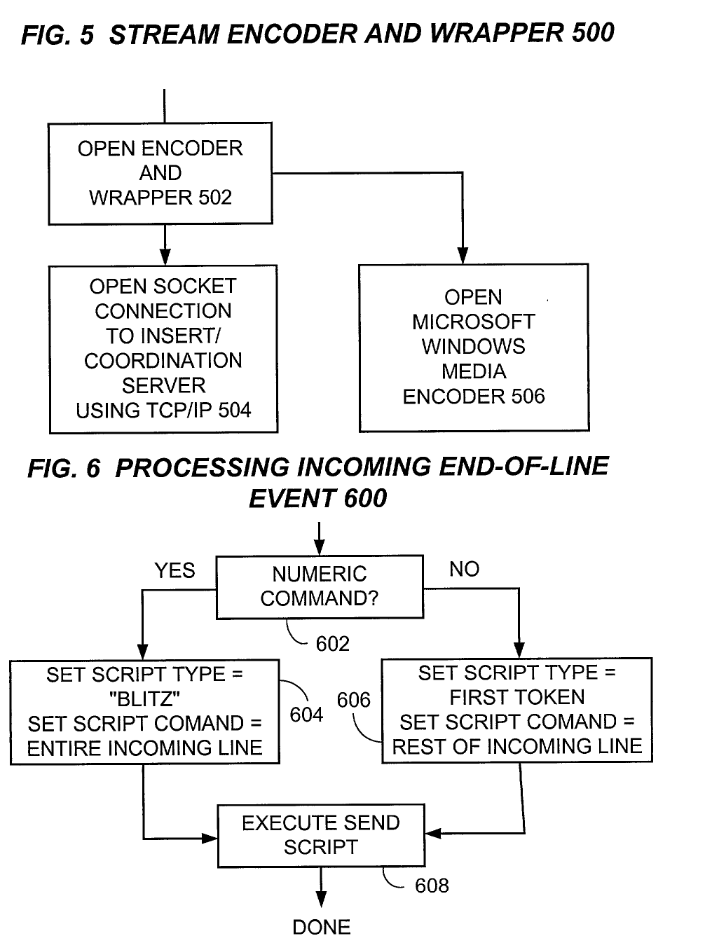

Digital information and messages generated at 210 by the server 200 is fed to the stream encoder and wrapper 105 not over a direct path, as is suggested in simplified FIG. 2, but through the Internet 106. With reference to FIG. 5, the stream encoder and wrapper 105 contains a stream encoder and wrapper program 500 which begins by launching itself at 502, and then at step 506 it opens Microsoft Windows Media Encoder which accepts and encodes the incoming audio stream and passes it on to the stream server 108. The Windows Media Encoder program also includes facility for accepting digital messages which it can convey along with the audio stream. Accordingly, at step 504, the stream encoder and wrapper program 500 opens an Internet TCP/IP socket Interconnection to the insert/coordinating server 200 using the TCP socket number 1200. Of course, any other convenient arrangement could be used to transfer this data between the server 200 and the stream encoder and wrapper 105.

As can be seen at 210 in FIG. 2, a variety of digital messages can be sent over this path to the listener's PC 110. These messages generally fall into two different classes: those that begin with a number, and those that begin with a command word. In general, the numeric commands relate to advertising display control while the commands beginning with a command word relate to the commands that are provided by the producer which update such things as the score and present messages concerning the status of the game. This division exists primarily for historical reasons, and clearly other embodiments of the invention could treat all the commands in the same way or use other protocols to transfer these commands.

Again referring to step 210 in FIG. 2, if the log file for a particular broadcast indicates that the next commercial has corresponding to it a rich media ad in the rich ad server 1700, then a reasonable time before the time when the rich ad is to be broadcast, a pre-cue command 101 identifying the rich ad by its Internet address is sent to the listener's PC 110 so that the listener's PC 110 may download the ad well in advance from the rich ad server 1700 and store it in the local rich ad buffer 112 before the ad is to be presented to the listener.

For example, the rich ad server 1700 might contain a visual only (no sound track) movie advertisement stored in the ad server 1700 under the name BlueLobster.der that corresponds to an audio advertisement in the audio ad database 208 stored in a file BlueLobster.wav. The log file causes the audio ad BlueLobster.wav to be inserted into the live broadcast without any image. However, the same ad could be accompanied by a video, in which case the pre-cue command would cause the video to be preloaded in the listener's PC 110 rich ad buffer 112; and then, at the time when the ad is to be played, a fire command 105 would be sent out to trigger the playback on the listener's PC 110 (through the media player 116) of the visual portions of the advertisement in synchronism with the stripped-in audio advertisement.

As another example, a pre-cue command 101 might cause the address of a Studebaker advertisement to be downloaded into the listener's PC 110 so that a full audiovisual Studebaker advertisement could be retrieved from the rich ad server 1700 and loaded into the rich ad buffer 112 before the time when the ad is to be played back. In this case, the listener's PC 110 would replace the audio soundtrack with that retrieved from the rich ad server 1700 in response to the fire command 105, so that the audiovisual advertisement from the rich ad buffer 112 is played back by the media player 116 as a complete replacement for the audio ad which otherwise would be presented to the listener's PC 110.

The command 103 allows the producer, using the producer's system 700, to send commands over the Internet 106 to cause audiovisual effects to be produced at the listener's PC 110. For example, one play movie command 103 can cause the movie “flag.der” to be presented by the media player 116 in the listener's PC to produce the image of a waving flag for a few seconds when some significant event occurs in the game. Likewise, a short audiovideo message such as “GoBigRed” might be signaled by sending the address “GoBigRed.der” to the listener's PC. These short moves are played back in the same manner as an advertisement, typically in the same window as rich media ads. If a rich media ad starts when such a producer effect is playing, the ad overrides the producer effect, and the software design prevents the producer from triggering effects during the presentation of ads that might otherwise disrupt the rich media ad playback.

Score windows presented by the tuner 114 to the user can be updated by means of update score commands “ASCORE” and “BSCORE” score. At the end of a quarter, a “QUARTER” command can be used to update the number displayed in a window that presents a number of the quarter on the listener's PC 110. As will be explained, the tuner 114 produces a scrolling text message window on the listener's PC 110, and the contents of this window can be set by means of a scroll message that is sent along with the “SCROLLER” command. In FIG. 2, the message sent is “QUARTERBACK INJURED SHOULDER.”

Along with the audio and rich advertisements, provision is made whereby conventional Internet banner ads may be set up on the listener's PC for the sponsors of the game. Two banner ad commands are provided, one to update the image in the banner, and one to update the hypertext address that is linked to the banner ad and that enables the listener to click on the banner ad and to be transferred to the web site of the advertiser. The “BANNER” command supplies an image, such as BlueLobster.gif, to the banner, and the “BANNERTGT” command provides the address to which the listener is to be transferred over the Internet if the listener chooses to click upon the banner ad.

With reference to FIG. 6, a program within the screen encoder and wrapper 105 called the processing end-of-line event program 600 accepts these commands from the TCP/IP socket 1200 and executes them, as is shown in FIG. 6. When an entire command has been received, as indicated by an end-of-line marker (such as a line feed or carrier return character), the program 600 examines the beginning of the command line at 602 to determine whether it is a numeric command or is prefixed by a command word. If the line has a numeric prefix, such as “101” or “103” or “105”, then a call is set up to the Windows Media Encoder program with the script type set to BLITZ and with the script command set to the entire incoming line, and this media encoder subroutine call is then executed by a call to the “Send Script” subroutine of the Windows Media Encoder program at step 608. On the other hand, if a word appears at the beginning of the line, such as “ASCORE” or “QUARTER, then at step 606 the script type is set equal to the first word in the command line, which is called the token in FIG. 6. The script command then becomes the remaining parts of the incoming line except for any leading blank spaces. This information is then sent to the Windows Media Encoder program by a subroutine call to the “Send Script” subroutine that is carried out at Step 608. The program shown in FIG. 6 is executed every time a complete digital command message, including an end-of-line marker such as a line feed, is received over the TCP/IP socket channel 1200 arriving from the insert/coordinating server 200 and originating either in the log file for a given broadcast (in the log database 300) or from the producer system 700.

The log database 300 and the audio ad database 208 are maintained in the preferred embodiment of the invention as an SQL server database. One log file is maintained for every broadcast made by a given insert/coordinating server 200, stream encoder and wrapper 105, and stream server 108, and for each day.

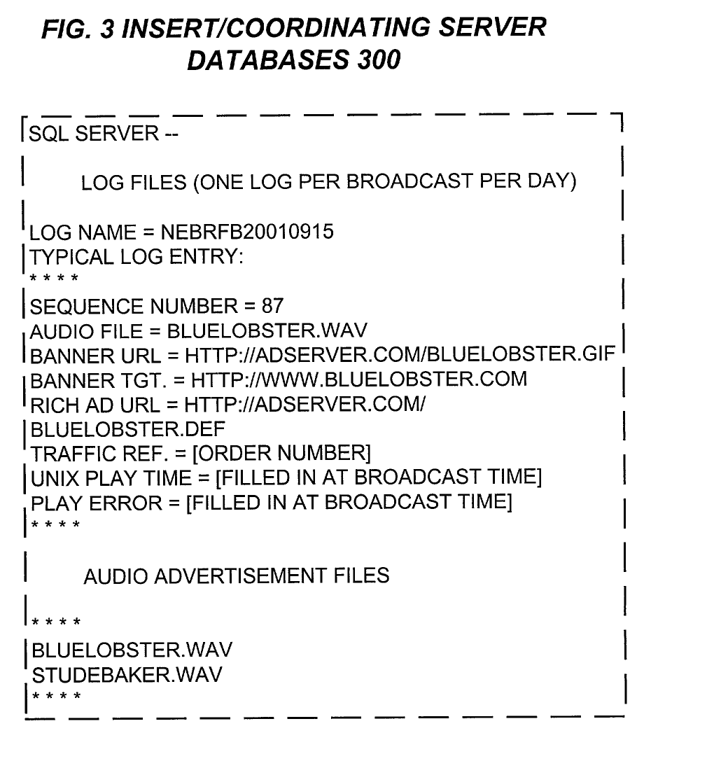

In FIG. 3, exerts from a typical log file for a given broadcast and for a given day are shown. These log files originate from the traffic system 800 which will described below.

A typical log file is assigned a log name, in this case NEBRFB20010915, which identifies this as the log file for a Nebraska football game scheduled to be played on Sep. 15, 2001.

This log file contains entries for every advertisement, each of which is identified by a sequence number, such as the sequence number 87 shown in FIG. 3.

The sequence number 87 specifies that the audio advertisement to be broadcast during the commercial break signaled by the 25 Hz tone is a “Blue Lobster” advertisement, and the compressed audio is contained in a compressed digital audio file named “BLUELOBSTER.WAV.” Before this audio advertisement is stripped into the live sports event audio stream, a “Blue Lobster” banner ad is to be displayed by the tuner 114. The address of the graphic image for this banner ad is contained in the rich ad server 1700, whose Internet address is HTTP://ADSERVER.COM, and the image file is “BLUELOBSTER.GIF.”Accordingly, the Internet address of the graphic image for the “Blue Lobster” banner is: <HTTP://ADSERVER.COM/BLUELOBSTER.GIF>. The Internet address to which listener's are sent when they click upon this banner ad is HTTP://BLUELOBSTR.COM or some other equivalent address of the company paying for this ad. Note that this banner ad is downloaded and then remains displayed by the tuner 114 to the listener for an extended time interval, all during the game play, until some other banner ad is sent down at the command of some other log file entry with a higher sequence number. The banner ads can match the audio ads, as shown in FIG. 3, or they can be ads for different sponsors, and the ads can be priced and marketed accordingly.

If there is a rich advertisement in the rich ad server 1700 corresponding to a given time slot, its Internet address also appears in the log entry. In this case, the rich ad's address within the rich ad server 1700 is “HTTP://ADSERVER.COM/BLUELOBSTER.DEF. The insert/coordinating server 200 sends this address down to the tuner 114 well before this ad is to be performed so that it may be slowly downloaded into the rich ad buffer 112 well ahead of time.

The “TRAFFIC REF” Is a number assigned to this set of advertising data in the log entry by the traffic department for administrative and billing purposes.

The “UNIX PLAY TIME” is the Grenwich Universal time record of when the advertisement was actually played, and the “PLAY ERROR” is an error code indicating whether the advertisement was broadcast, or whether there was a error in its broadcast; and if so, the code identifies the error. These two fields of each log entry in each log file are empty when the log file is initially sent to the insert/coordinating server 200 prior to each broadcast. The server 200 enters appropriate data into these fields when each ad is broadcast. Then, after the broadcast, the server 200 sends the log file back over the Internet to the traffic system 800 which reviews the log file and makes the necessary adjustments for advertisements that were not actually broadcast, as will be explained in conjunction with the explanation of FIG. 14 set forth below.

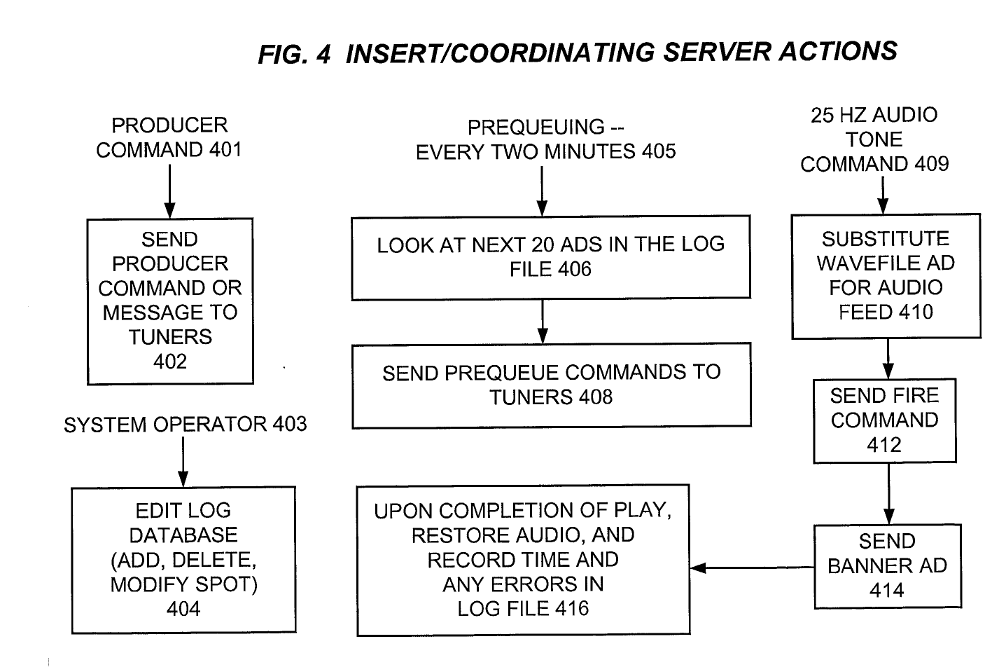

The program steps carried out by the insert/coordinating server 200 are summarized in FIG. 4.

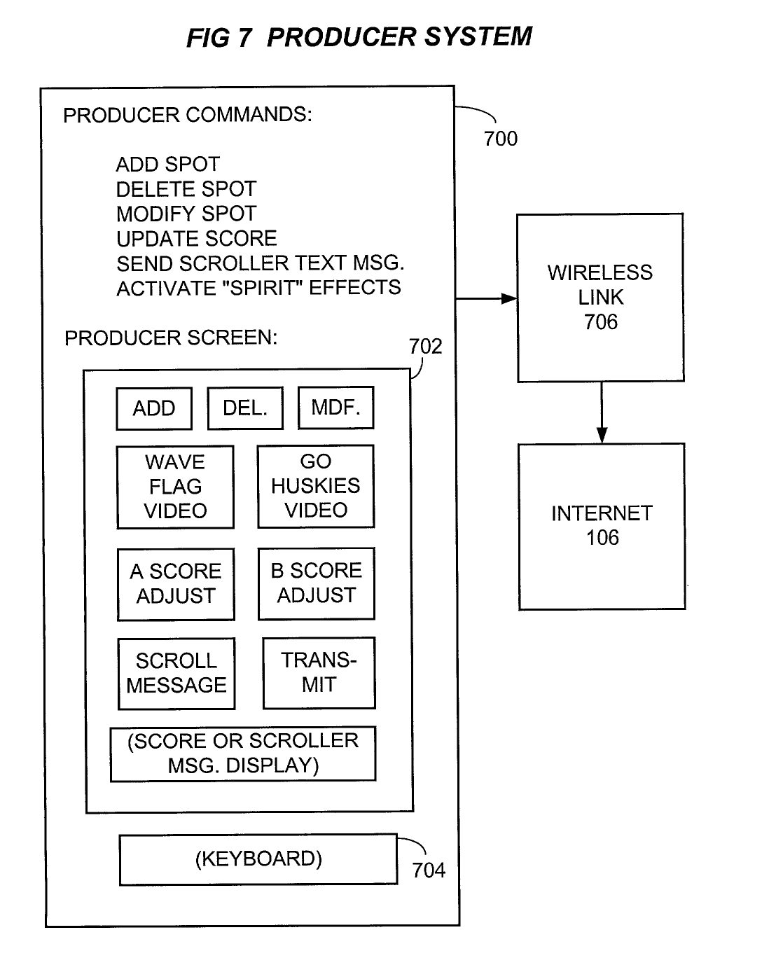

In response to a producer command, received over the Internet from the producer's computer system 700 shown in FIG. 7, the server 200 simply sends the producer command directly on to the tuners 114, as is indicated at 402. The command is routed directly and immediately over the Internet to the stream encoder and wrapper, where it is processed in the manner already explained in conjunction with FIG. 6.

Another function of the insert/coordinating server 200 is facilitating the live editing of the log databases, such as the sample database shown in FIG. 3. A system operator 403, who works from their own personal computer, may access the server 200 through the Internet and call up any log file from the SQL log database 300 and then add, delete, or modify any spot, as is indicated at step 404. In this manner, last minute changes and corrections to a days program may be made, even immediately prior to or during a broadcast.

The insert/coordinating server 200 performs pre-queuing steps every two minutes, as is indicated at 405 in FIG. 4. The server reviews the next twenty log entries for the next twenty ads in the current log file (step 406), and it locates and retrieves the rich ad URLs and then generates pre-queue commands for each one. These commands are routed over the Internet to the stream encoder and wrapper 105 and are delivered well ahead of time to the tuners 114, as is indicated at step 408. In this manner, the rich ads are downloaded from the rich ad server 1700 well before it is time for them to be broadcast, and they are stored in the rich ad buffers 112 within the listener's PCs.

It was explained at an earlier point that twenty-five cycle inaudible tones in the broadcast are detected by a tone decoder 104 which signals the control logic 202 within the insert/coordinating server 200. This action is indicated in FIG. 4 by the step 409, which is labeled 25 Hz audio tone command. In response to this tone signal, indicating that it is time to insert an audio commercial as a replacement for the material being broadcast, the server 200 substitutes for the audio feed the wave file ad that is indicated by the current entry in the current log file and that is retrieved from the audio ad database 208. This is indicated at step 410 in FIG. 4. Very shortly thereafter, or perhaps at the same time, the server 200 sends a fire command 105 over the Internet to the stream encoder and wrapper 105 to trigger the listener's PC 110 tuner 114 to begin the play of any rich ad which has been queued up to be played at that time. This is carried out at step 412 in FIG. 4. Next, at step 414, a banner ad corresponding to the advertisement is also transmitted to the tuners 114 as part of the “BANNER” and “BANNERTGT” commands which were explained above, using the names of the banner graphic file and the advertiser's web address which are retrieved again from the current entry in the log file.

After the advertisement has been broadcast, the switch 206 is returned to the position that permits normal audio play; and at step 416 in FIG. 4, the time of advertising play and the existence of any error is recorded in the log file entries, as was described in conjunction with FIG. 3. (FIGS. 5 and 6 were described above in conjunction with the description of FIG. 2.)

FIG. 7 presents the producer system 700. The streaming Internet producer is the individual who is managing the Internet broadcast, and who may be actually present at the game to observe what is happening on the playing field. Typically, a team of engineers, broadcasters, and a producer from a radio station are in charge of producing the audio and possibly the video narration of the game, its transmission to satellites, and the insertion of the twenty-five Hz inaudible tone bursts plus any default ads that the broadcast may contain. FIG. 7 is a computer system that is used by a separate producer of the Internet broadcast who has virtually no control over the audio broadcast. The streaming Internet producer must listen to the live broadcast (not a buffered/delayed Internet stream) so the effects will coordinate with the live broadcast.

The producer may sit in the stands during the game with a wireless, battery powered portable computer 700 having a screen 702 and a keyboard 704. The producer could also view the game by television, or at the least must be listening to the live broadcast of the game. The computer 700 includes some form of wireless link 706 to the Internet 106, which could be a radio link to a base station located in the sports arena, or it could be a direct satellite or cellular telephone link to the Internet. In the case of college sports events, the producer might typically be a student who is knowledgeable concerning sports, who has material identifying the various players and explaining the past histories of the team, and who is therefore qualified to add interesting commentary to the broadcast just for the Internet listener's.

The producer's screen includes a variety of touch buttons which may be activated to do such things as adjust the score setting in the A or B score windows on the tuner 114, display a multimedia presentation of a waving flag, for example, or a GO HUSKIES GO video message, on the listener's PC 110, and perform other such functions, setting them up by depressing a button (or touching a touch-sensitive screen) and then executing them by pressing the “transmit” button (or screen area). In addition, and using the keyboard 704, the producer may type in a message explaining what is happening on the field or providing background information, and this message would be scrolled across a special scrolling window of the tuner 114 within the listener's PC 110.

In addition, and more directly relating to the advertisement delivery functions of the invention, the producer includes commands for editing presentation of advertisements and, in particular, adding a spot, deleting a spot, or modifying a spot by sending commands to the insert/coordinating server 200 to be carried out by the step 404 shown in FIG. 4. The producer thus has the last word on coordinating the advertisements with the actual play of the game and can make changes when necessary to ensure an orderly presentation of information to the listener's.

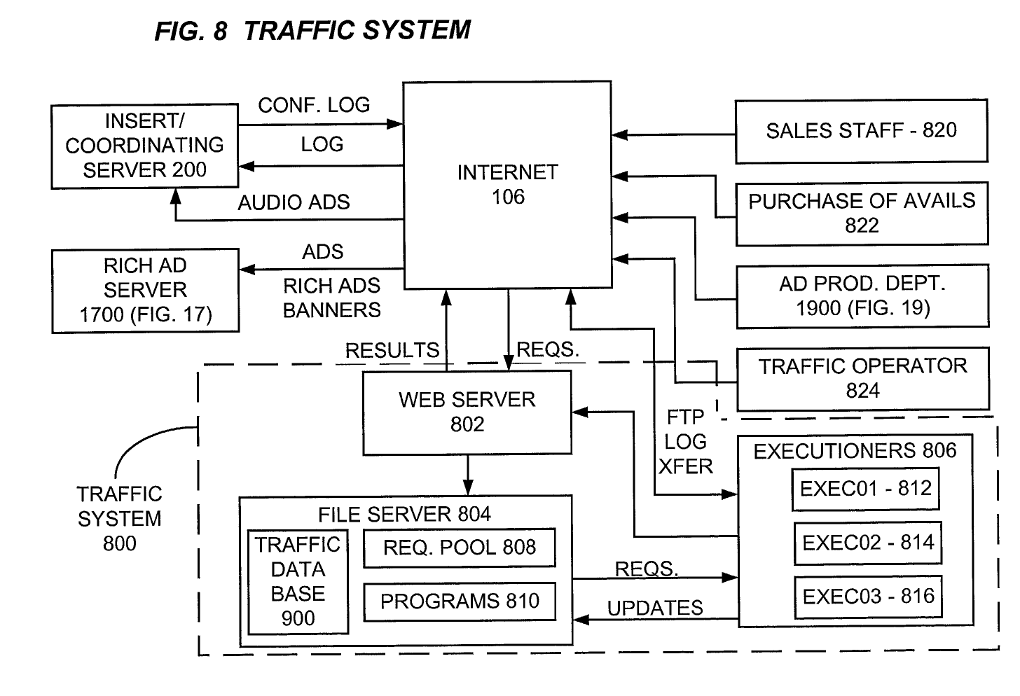

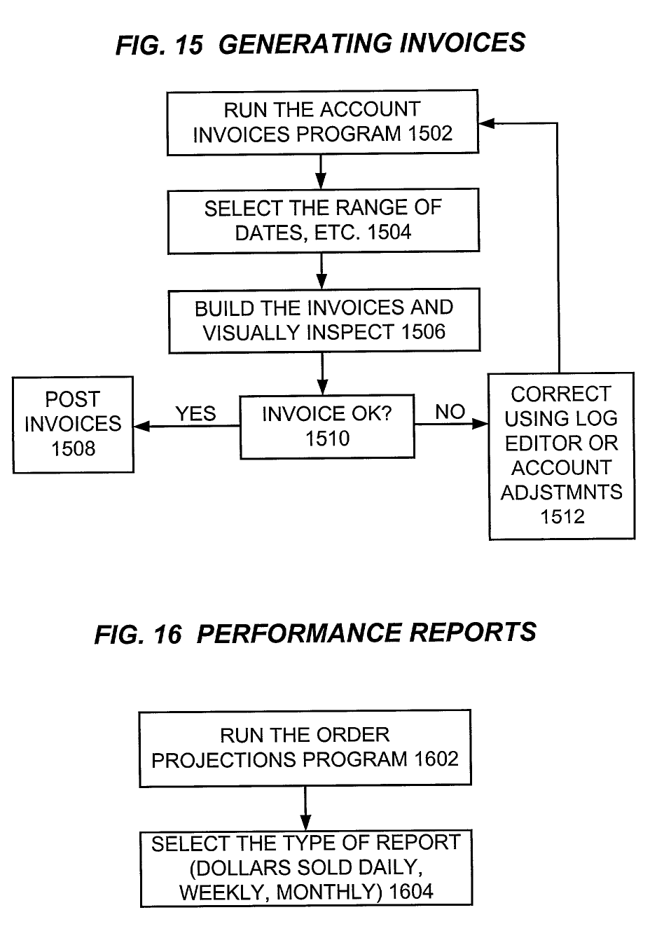

FIGS. 8-16 present an overview of the traffic system 800 which manages the definition of avails, their marketing and sale, the development of program logs, the processing of the play records from programmed logs that have been executed, the generation of client invoices, and the production of performance reports on all aspects of the business end of the Internet sport broadcasting system 100 when viewed as a vehicle for marketing advertising opportunities. In radio and television broadcasting, traffic systems based on computer technology are well known and are widely used. Accordingly, the description of the FIGS. 8-16 will focus upon the ways in which the traffic system 800 differs in its details from a typical traffic system of the type to be found, for example, in a normal radio or television broadcast station.

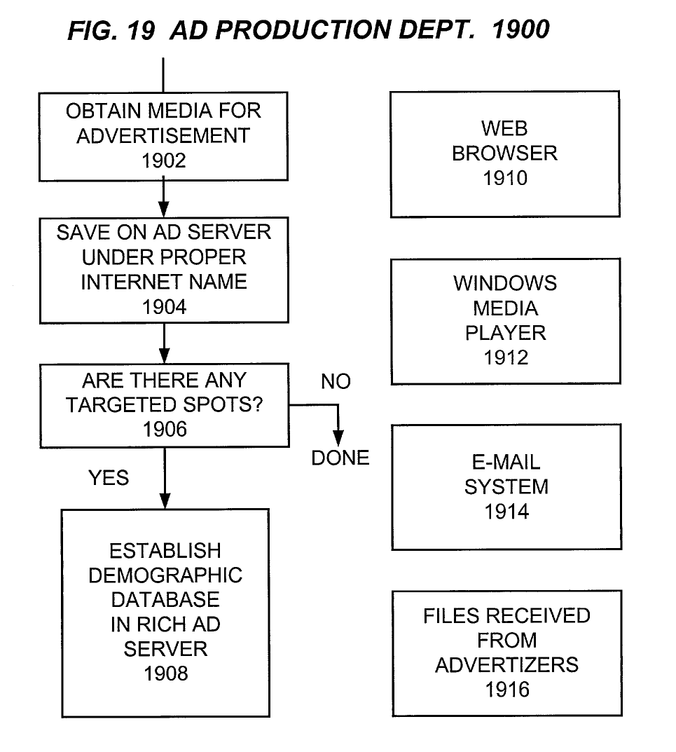

FIG. 8 shows the hardware details of the traffic system. It centers around the Internet 106 which serves as a network coupling between the traffic system 800 and the other components of the complete system. Briefly summarized, a sale staff 820 accesses the traffic system 800 to learn what advertisement opportunities are available and to present those to prospective clients, who may themselves be given limited access to the traffic system 800 to view available avails, but with pricing and other details possibly suppressed or customized for the benefit of particular clients. The purchase of avails at 822 is also managed by the traffic system 800. Once an avail has been sold, then it is necessary to associate those avails with media, both audio advertisements as well as audiovideo material. The obtention of this material, the installation of it in the rich ad server 1700, and the coordination of that with the log files is managed by the ad production department 1900 (see FIG. 19). Finally, the traffic system 800 builds the log files, transfers them over the Internet to the insert/coordinating server 200, and sees that they control the broadcasts which are produced. After the broadcasts are completed, the confirmation log files are transferred back from the server 200 into the traffic system 800 where they can be examined and used to control the generation of invoices for particular clients.

From a hardware prospective, in the preferred embodiment of the present invention, the traffic system 800 includes a web server 802, a separate file server 804, and one or several separate computers each containing one or more executioners 806, such as the three exemplary programs 812, 814, and 816 shown in FIG. 8. These three components function together in a carefully coordinated fashion as an integrated web server that is designed to handle a high volume of requests from many individuals scattered over the Internet and using individual web browsers to request all kinds of functions and information from the traffic system 800.

The web server 802, operating under Windows NT, receives the requests from the Internet for data retrieval or for data processing. In response to each request, the server launches an instance of a very simple program named “SC.EXE” which places the request into a request pool 808 residing in a Netware file server 804 and then suspends itself. The programs for servicing these requests, written in Delphi Pascal, also reside on this server 804. These Pascal programs define the data structure of the traffic database 900 which resides on the Netware file server 804. Clearly, other types of servers and databases and program design techniques could be used to build such a system.

The executioners 806 are process threads one or more of which are running upon any necessary number of individual computers, operating under Windows 98, to spread out the load as needed and to meet user demand. More executioners and executioner computers may be added to the system as the load grows over time. Each executioner 812, 814, and 815 retrieves a request from the request pool 808 and then executes the request, working with data in the traffic database 900; then the executioner returns to the request pool for another request. The results of the executioners processing requests is partly stored as updates to the database 900 and is partly sent back through the web server 802 to the requesters, as when a report is requested. After a request is fully processed, the executioner deletes it from the request pool, and then the program se.exe running on the web server terminates after notifying the requester that the request has been fulfilled.

At the heart of the traffic system 800 is a traffic database 900 which is contained within the file server 804. This contains all of the information defining the sports radio broadcasting schedule for the next several months, the definition of avails within those individual broadcasts, a record of which avails have been sold to which advertisers, a record of the log files which have been built out of these records, a record of the confirmation logs which have been returned the following broadcasts, and finally, a complete invoice generating system and accounting system that keeps track of accounts receivables and other accounting information.

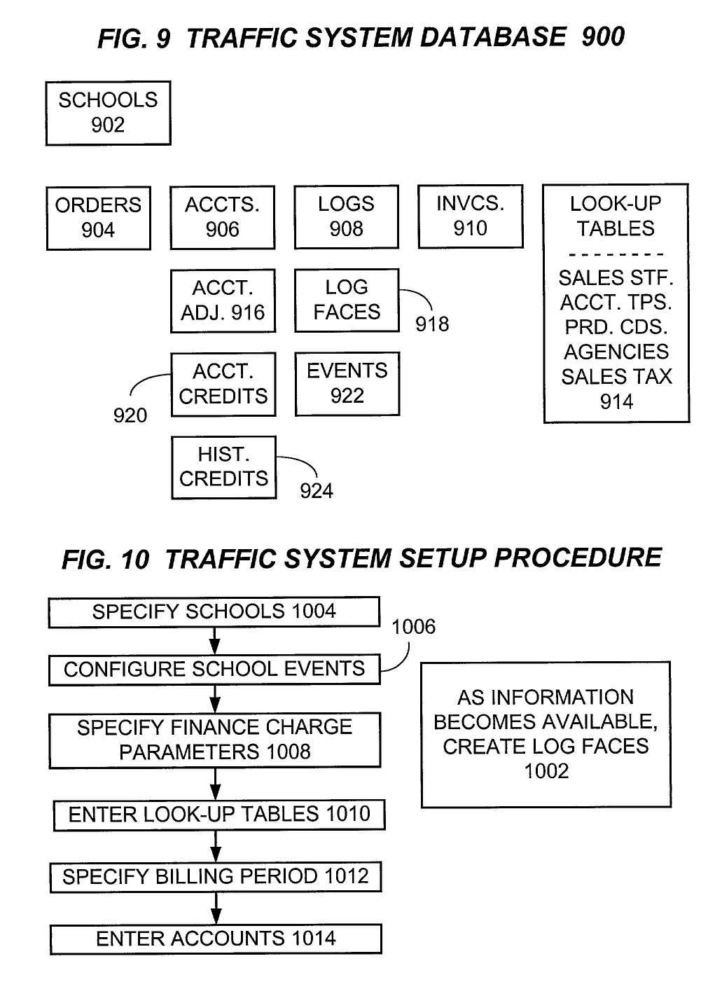

FIG. 9 discloses the elements of the traffic database 900. A school database 902 contains the names of all the schools. A list of Events is maintained at 922. Each event is a game or a set of related games having a start date, an end date, and a schedule of advertising spots classified as pre-game, play-by-play, or post game. A rate may be specified for each type of spot. Each event thus defines a certain number of avails, or advertising opportunities. When one or more avails for an event are sold, an order record is created and placed into an order database 904. Each order specifies one or more events, an account number, a sales representative number, and also an audio source file, a banner linkage, and optionally a rich ad linkage. These may not be available at first but are filled in by the ad production department as this information becomes available.

A typical event might specify that it is a Nebraska football game containing the following advertising opportunities:

NEBRASKA V. OPPONENT Sept. 15, 2001

| | Break No. | Duration |
|---|---|---|
| Pregame | 1 | 2:00 |
| | 2 | 1:30 |
| | 3 | 2:00 |
| | * * * * * * | |
| Play-by-play | 1 | 1:30 |
| | 2 | 2:00 |
| | 3 | 1:30 |
| | * * * * * * | |
| Postgame | 1 | 1:30 |
| | 2 | 2:00 |
| | 3 | 1:30 |

In the above chart, the times are minutes: seconds and specify the duration of the advertising breaks planned for this particular game.

Logs are generated from the order 904 and events 922 information. These logs then control the actual broadcast of advertisements during the game, and afterwards they are returned to the database 900 with time and error information added, as has been explained. Log faces include day by day program names—what is happening during each day. Log faces are maintained at 918 and are displayed to identify with particularity the broadcast program associated with avails. Log faces are built over time.

After a broadcast, account adjustments 916 (account number, + or −, and the number of spots) are developed, and then invoices 910 are generated and sent out. The invoices are generated from the examined and confirmed log files. Payments are recorded as account credits, as are adjustments that are fixed by write downs rather than by the delivery of compensating avails. A history file of account credits is also maintained at 924.

Various look-up tables are included in the database at 914. These include lists of the sales staff, account types (local, national, etc.), advertisement product codes (unique codes assigned to cars, refrigerators, etc.), list of ad agencies and other customers (including name, address, etc.), and state sales tax tables that are needed when computing the invoices due to different customers.

FIGS. 10 through 16 present overview flow diagrams of the processes carried out by the traffic system executioners. These programs work in conjunction with the traffic database 900 in response to a variety of commands received from numerous users operating on computers equipped with web browsers.

In FIG. 10, the setup processor for the traffic system is disclosed. First, at 1004, the schools are specified for the school database 902. Next, at 1006, school events are configured for the event database 922. The finance charge perimeters, which define how much an avail will cost, are entered next at step 1008. Next, at 1010, the look-up tables at 914 are entered. The billing period is then defined for the system at step 1012, and then the accounts information is entered at 1014.

Next, as the year progresses and as the schools develop their athletic calendars and determine who they will be playing, the log faces are created at step 1002 and are entered into the log faces database 918, and the events 922 are developed.

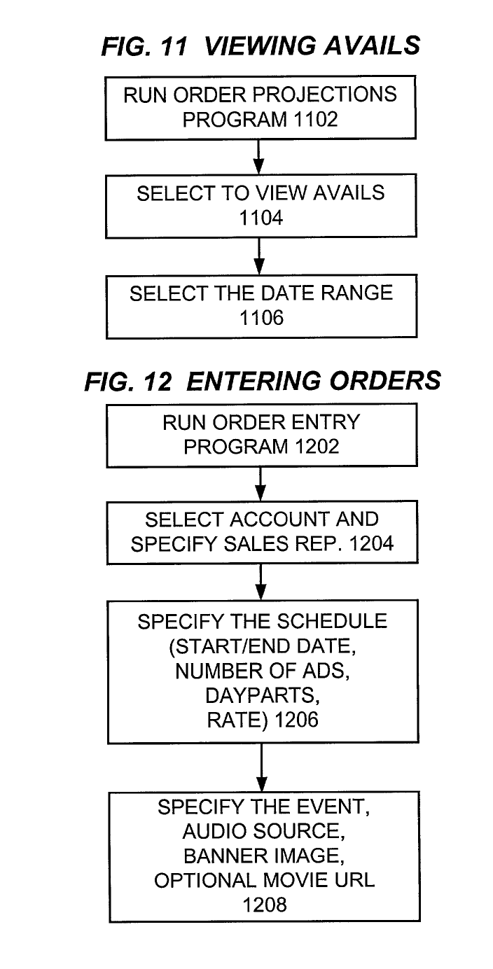

FIG. 11 illustrates the order projection program 1102 that facilitates the viewing of sets of avails. First, the user makes the necessary selections to view the avails at step 1104. This may include selecting the date range at 1106 and also specifying whether pregame, postgame, play-by-play, or both or all three types of avails are desired; which teams or groups of teams are desired; what time of day (or “day part”) is desired; and other such details to limit the scope of the search. The program 1100 then finds and presents a list of suitable and available avails to the user.

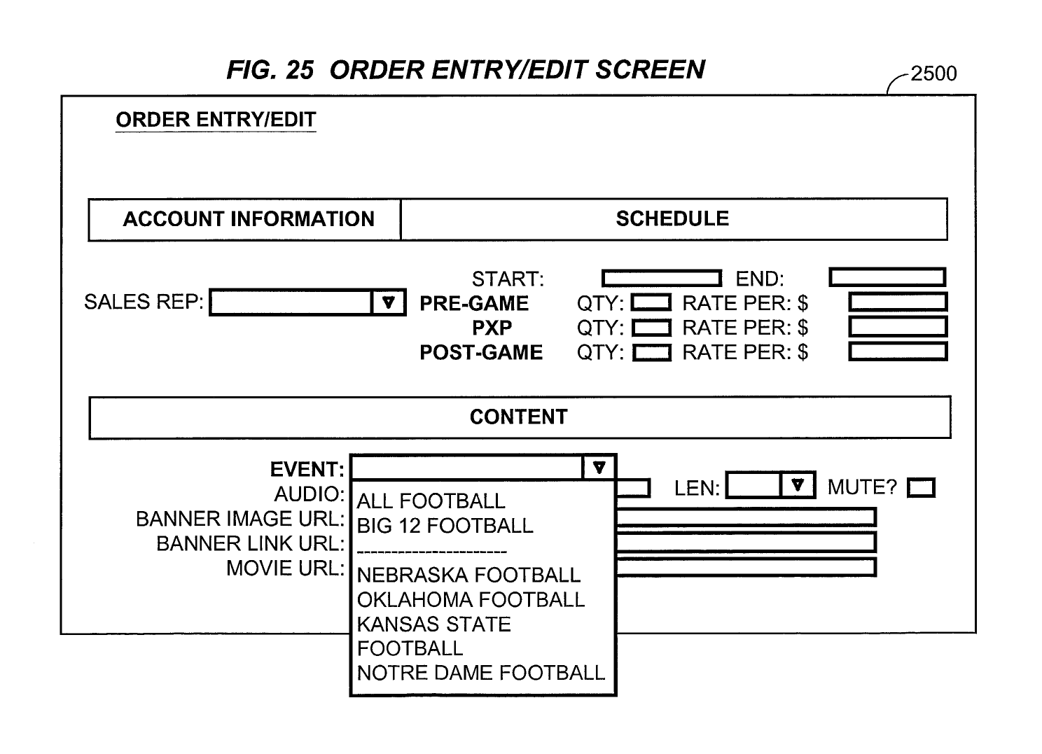

When an order is entered, the order entry program 1202 displays the order entry/edit screen 2500 shown in FIG. 25. First, at step 1204 (FIG. 12), the user selects an account (not shown in FIG. 25) and a sales representative (using the pop-down menu labeled “SALES REP” in FIG. 25). Next, at step 1206. and using the form shown below the word “SCHEDULE” in FIG. 25, the starting and ending dates of the advertising campaign are specified, and the quantity of pre-game, play-by-play, and post-game advertising spots are specified, to be purchased at the price disclosed or negotiated. The final step, 1208, is to specify the event along with the Internet addresses of the commercial's audio file, banner graphic and web page files, and optionally the commercial's multimedia presentation or movie file. The event is selected by means of an “EVENT” pop-down menu in FIG. 25. As can be seen in this example, “all football” may be selected, purchasing available spots in all college football games nationally; or just the games of one league may be selected, such as the big 12; or spots in the broadcast of any individual team may be selected. Then the Internet addresses of the audio, banner image and link, and movie are filled in, or they may be filled in later by the production department. The “LEN” popdown menu permits the length of the spot to be specified. The “MUTE?” check box permits the standard audio soundtrack to be muted and replaced with that of the movie or rich media advertisement.

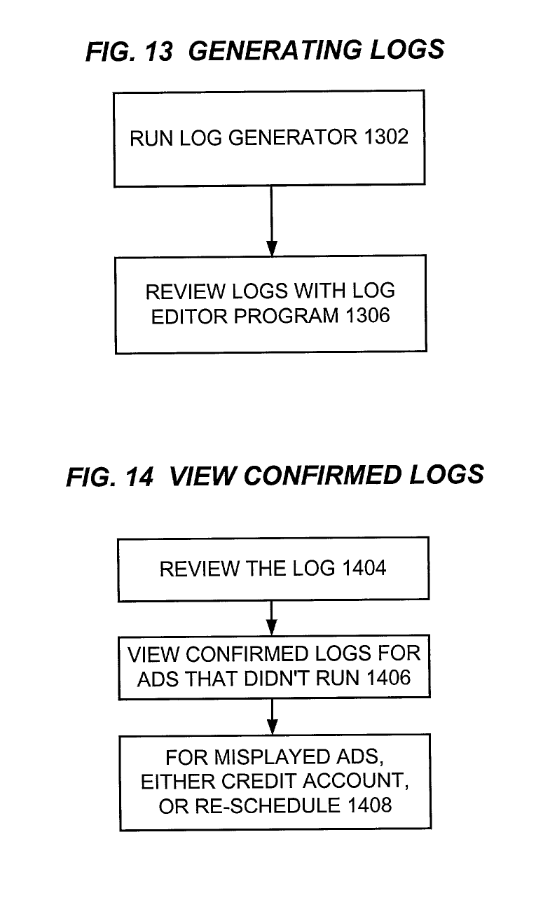

Prior to every game, the log file for each broadcast must be generated by the program 1302 shown in FIG. 13. This program generates the log files automatically. After a log file is generated, a traffic operator 824 (FIG. 8) may review the log file entries and make changes, for example, if two automobile advertisements wind up appearing one after the other, as indicated by a number that is associated with each log file entry.

With reference to FIG. 8, the finished log file is transferred by FTP file transfer from the traffic system 800 (and in particular, from the traffic database 900) over the Internet 106 to the insert/coordinating server 200. And after each broadcast, the modified log file, with the addition of broadcast time and error indications (as described above), is transferred back to the traffic system 800 by another FTP Internet file transfer operation.

After each broadcast, the traffic operator uses the program 1404 shown in FIG. 14 to review the log, paying particular attention to any play error indications that are recorded in the log file. The traffic operator views the confirmed logs for advertisements that didn't run at step 1406, and either credits the purchaser's account or else re-schedules the advertisement to play on some other day at step 1408.

Next, the program 1502 goes through the confirmed log files and generates account invoices. A range of dates for the invoice is specified, such as September 1 through September 30. Next, the invoices are built and are then visually reviewed at step 1506. If they are OK at step 1510, then they are posted to client accounts at 1508. If there are problems, or if there is a need for adjustment, then the invoice is corrected using the log editor or simply by making account adjustments at step 1512.

Performance reports, generated by a program 1602, are needed to advise sales employees of how they are doing as well as to compute the compensation of sales employees and to assist management in judging their performance. The operator simply selects the type of report to be generated and the range of time that it is to cover, and then generates the report at step 1604.

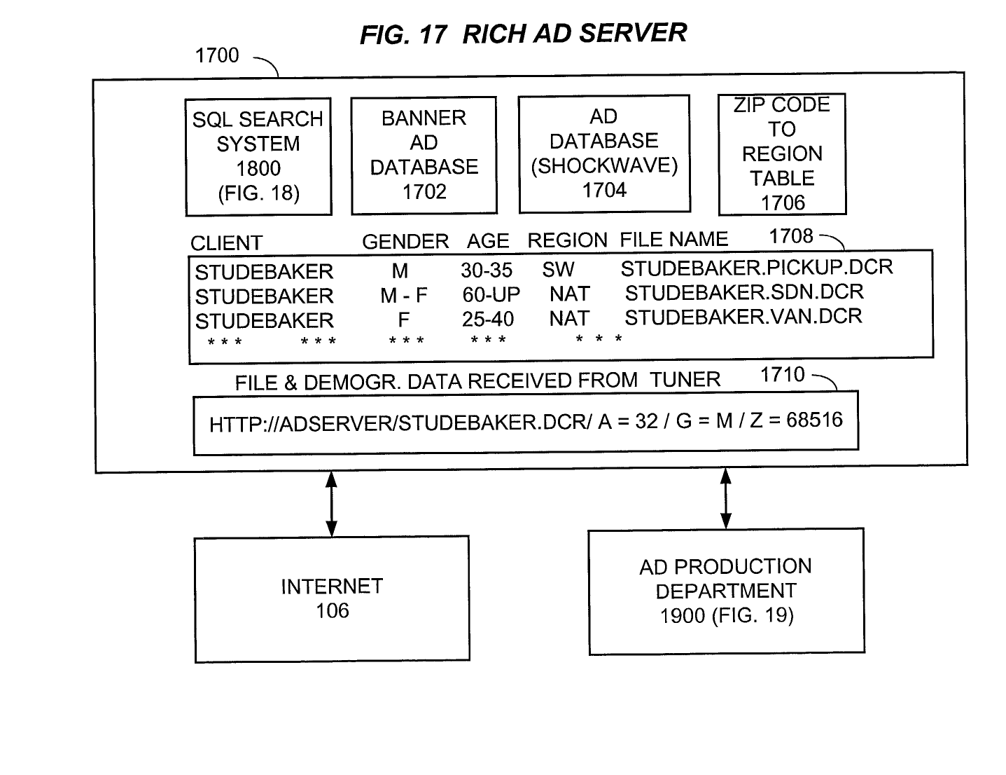

The rich ad server 1700 is shown in FIG. 17. As explained above, it contains a banner ad database 1702 which contains the graphics for the banners. It also contains a multimedia advertisement database 1704. In the preferred embodiment of the invention, these files are Shockwave movie files.

The rich ad server is the element of the invention which determines what advertisement is presented to different tuners, in accordance with demographic information contained within the tuners and not stored centrally.

When a tuner requests the downloading of a “rich” advertisement or movie, it attempts to download that advertisement from the rich ad server, as has been explained. If the tuner has gathered demographic information from the user, this information is uploaded to the rich ad server along with the download request. The download request, plus the demographic information, is temporarily stored within the rich ad server at 1710. Note that the identity of the listener is not recorded. The rich ad server only knows that an individual with a particular set of demographics is at a particular Internet Protocol address somewhere out on the Internet.

And since Internet Protocol addresses are normally not permanently assigned to any one individual or household, the identity of the individual remains concealed. Even in those instances where an individual always uses the same Internet Protocol address, still the rich ad server 1740 has no way of identifying that individual. In addition, after downloading the requested advertisement, the rich ad server 1700 discards, and does not retain, any of this information. Accordingly, personal privacy is protected.

The rich ad server 1700 does not always return the multimedia advertisement requested by a given tuner 114. In some cases, the rich ad server 1700 may have several different advertisements each associated with a different viewer demographic profile. Accordingly, the rich ad server 1700 may return to each tuner 114 an advertisement provided by the same sponsor that most closely matches the demographics of the individual listener at the tuner. In this manner, the advertising is demographically focused but without any invasion of personal privacy.

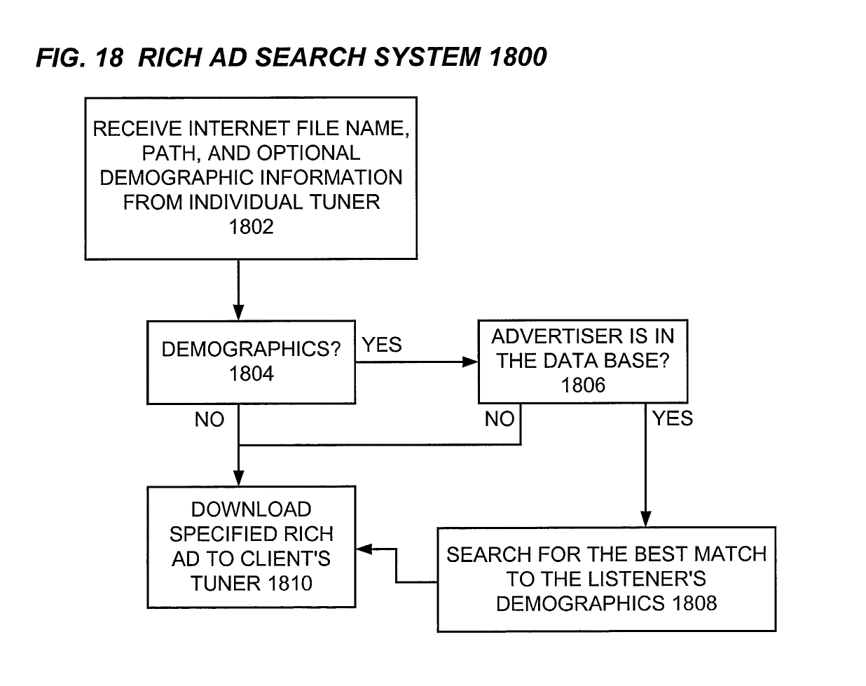

FIG. 18 illustrates the rich ad search system 1800. After the rich ad server 1700 receives an Internet file name, path, and obtional demographic information from an individual tuner at step 1802, it tests for the presence or absence of demographics at 1804. If none are provided, then the rich ad requested by the tuner 114 is downloaded to the tuner 114 at step 1810. This same course is followed if there is only one advertisement, as is indicated by the fact that the advertiser is not listed in the rich ad server's demographic database 1708 (FIG. 17).

But if step 1806 locates an entry, for example, for Studebaker in the database 1708, then at step 1808, the best match between the listener's demographics 1710 and the Studebaker entries in the database 1708 is selected, and that Shockwave multimedia file is downloaded to the tuner 114. For example, in FIG. 17, the demographics at 1710 indicate the listener's age (“A”) is 32, the listener's gender (“G”) is “M” or male, and the listener's zip code (“Z”) is “68516,” which the zip code region table 1706 says lies within the southwestern part of the United States. Accordingly, while the tuner requested the downloading of the “generic” Studebaker advertisement “STUDEBAKER.DCR.” the rich ad server's rich ad search system 1800 returns to the tuner the Studebaker advertisement “STUDEBAKER.PICKUP.DCR” which is targeted for 30 to 35 year old males living in the southwestern united states (“M”, “30-35”, “SW” at 1708 in FIG. 17).

The rich advertisements are loaded into the rich ad server 1700 by the ad production department. FIG. 19 illustrates at 1900 some of the tasks carried out by this group of professionals. As shown in FIG. 19, the computers used by this department are equipped with web browsers 1910 equipped with Windows Media Player 1912 and e-mail systems 1914. This department obtains advertisements from the advertisers (step 1910) in a variety of ways—by direct delivery of CD, DVD, tape, and other media, by FTP file transfers, and even by satellite downloading. At step 1902, the media is obtained, and at step 1904 it is saved on the rich ad server under the proper Internet name that appears in the Log files (the orders 904 and logs 908 may need to be adjusted). If there are no targeted spots (step 1906), then the production department is done with its work. But if there are several multimedia ads targeted at different audiences, then the ad production department must establish the demographic database 1708 within the rich ad server 1700 so that the proper advertisement will be delivered to each individual's tuner 114, as has been explained.

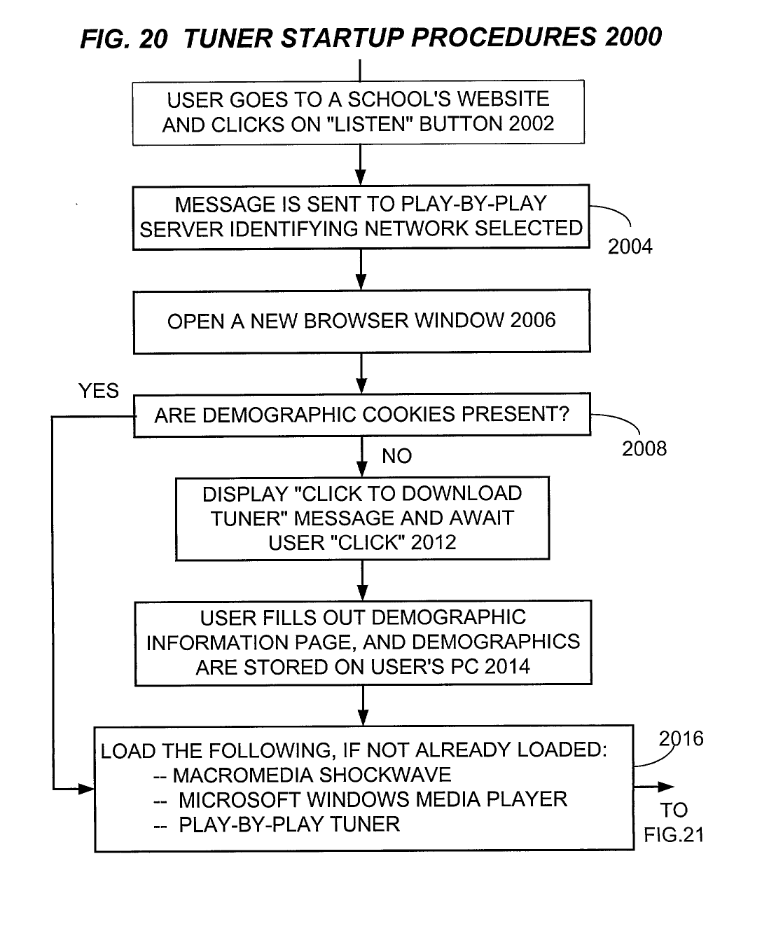

The remaining figures, FIGS. 20-24 and 26-27, explain the details of the tuner 114 within the listener's PC 110, and how the tuner 114 interacts with the local rich ad buffer 112 into which multimedia ads are downloaded ahead of time by the system 100 and also how the tuner 114 interacts with the media player 116.

FIG. 27 shows the tuner screen 2700, which appears on the face of the user's personal computer 110. It is broadcasting a University of Nebraska game. It is the third quarter, and Nebraska leads by a score of seven to zero, as can be seen. These values, plus any text displayed in the scrolling window 2704, comes from the computer 700 of the producer, who is watching the actual game. The banner ad 2706 is the ad set up by the commands “BANNER . . . ” and “BANNERTGT . . . ” which the tuner 114 received from the insert/coordinating server 200 and which originated in the log file entry 300 for the spot about to be presented. An interactive shockwave movie 2708 appears when commanded to be displayed by the depression of a button (or the touching of a touch-sensitive screen) at the producer system, such as the “WAVE FLAG VIDEO” and “GO HUSKIES GO” buttons (or screen regions) shown at 702. And when a rich ad is to be displayed, it appears in the rich media ad window 2702. A lower border of the window reports the status of the live audio broadcast, with the word “PLAYING” and the time of playback “00:06” indicating that the playback has continued for six seconds so far. A small loudspeaker icon can be clicked upon to produce a volume control which can be adjusted using the computer's mouse. The second digit in the label “0 OF 0” indicates the number of rich media ads the insert/coordination server has instructed this listener's computer to prequeue. The first digit in this same label is the number of those ads that have been completely received and that are ready to play. For example, “2 of 3” means of the three upcoming rich media ads the tuner needs, it has completely received two of them. The size and positioning of the various windows is determined by a web page called a “network configuration file” defining the layout of the tuner windows, and this can be varied from broadcast to broadcast as part of the tuner setup procedure.

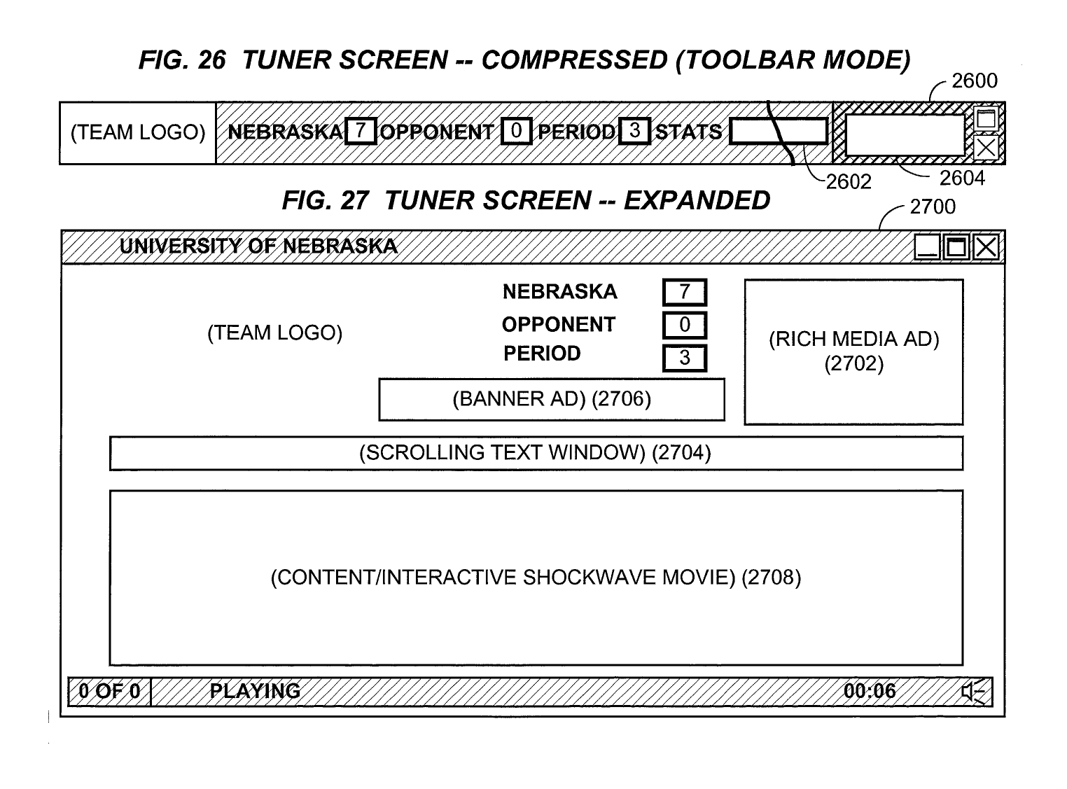

FIG. 26 shows the appearance of the tuner screen when the “reduce” box in the upper-right corner of the tuner window is clicked. The tuner then drops down and becomes part of a Windows-based PC's toolbar, along with the START command and other toolbar items, thus permitting other programs to be run above this tuner toolbar at almost normal size. As can be seen, the team logo appears to the left, reduced in size. The score and period are shown, and a “STATS” window appears in place of the scrolling text window 2704 (the broken line across the window 2704 indicates that part of it has been omitted, and it is longer than is shown in FIG. 26). The advertisement window 2604 is used for the clickable coordinated banner ad (the same item as 2706 on the expanded tuner). In the compressed toolbar mode tuner, the rich media ads are presented in a slide-up “always on top” window that appears just above the window 2604 for the duration of any rich media ad or producer effect. This window slides back down when the rich media ad or producer effect ends. As noted, this slide-up window is always on top of all the open windows, but it does not preclude the computer user from continuing to type a document, surf the web, etc., in whatever window they have open above the compressed toolbar tuner.

FIG. 20 sets forth the steps that install the tuner 114 on the listener's PC 110.

At step 2002, the listener, browsing through a school's website, comes across an announcement of the live sports broadcast, and the listener clicks upon a “Listen” button. In response, at step 2004, the listener is routed to a “play-by-play” server, and the server receives a message identifying the sports network which the listener has selected. Accordingly, the server opens a new browser window on the listener's PC 110 (step 20067). The server inquires at step 2008 whether the listener's PC 110 already contains a play-by-play demographic cookie. If yes, that indicates the listener has previously participated in a play-by-play broadcast, and accordingly the startup process can skip ahead to step 2016.

If no cookie is found, then this is a new listener. Accordingly, a “click to download tuner” message is displayed (step 2012), and the setup procedure awaits the listener to “click” at step 2012. Next the listener is asked to fill out a demographic information form, which is stored on the listener's own PC, and the listener is so advised. For example, the listener is asked to state his or her gender, age, and zip code; and also the speed at which the listener communicates over the Internet.

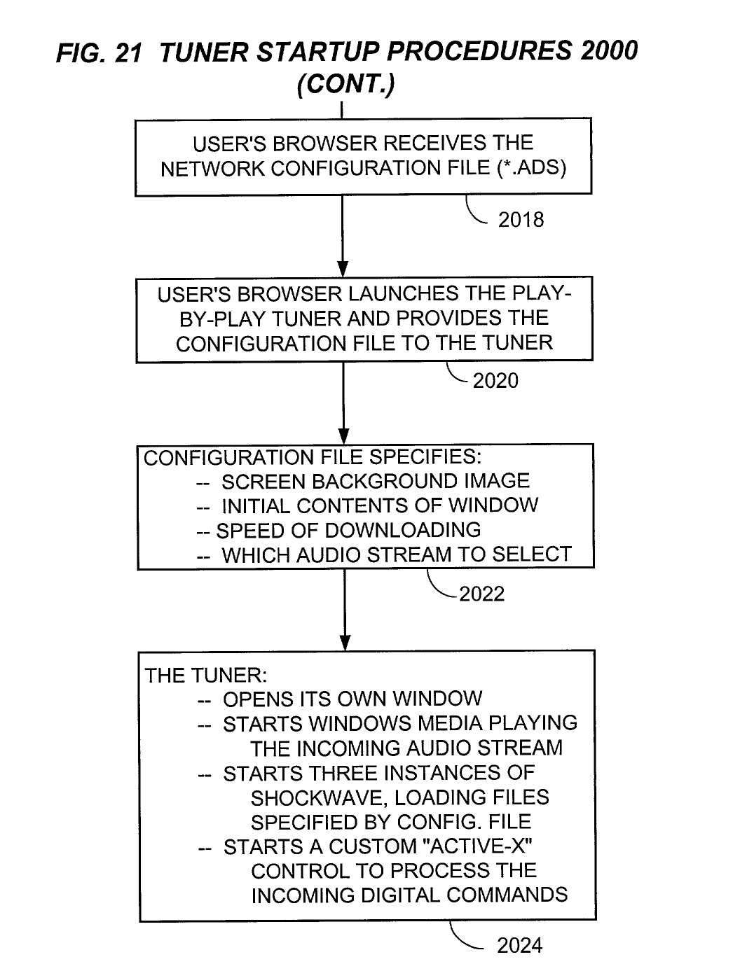

At step 2016, if not already loaded, the following components are downloaded to the listener's PC 110: Microsoft Windows Media Player (for reception and playback of the audio broadcast and the digital commands), Macromedia Shockwave (for playback of the multimedia advertisements and other movies and movie clips and animations), and the play-by-play tuner 114. Next, at step 2019 in FIG. 21, a network configuration file with the file extension “*.ADS” is downloaded to the listener's browser. Finally, at step 2020, the browser launches, as an independent task on the listener's PC 110, the tuner program, which is written in C++ and which creates its own window and fills it as if it were a web browser window but without the usual browser menu commands, as shown in FIGS. 26 and 27. The configuration file is passed by the web browser to the tuner program, and it causes the tuner window to appear, configured with the windows set as desired for the upcoming broadcast.

The configuration file specifies, among other things, the screen background image and the initial contents of the windows. It also specifies which broadcast stream to select. Accordingly, the tuner comes up with the team logo and other information shown in FIGS. 26 and 27 already in place (step 2022).

The speed of downloading is determined by testing data transfer from the streaming server site in a real time manner. The tuner 114 next carries out the steps specified at 2024: it opens its own window, launches Windows Media to begin the live audio broadcast, starts three instances of Shockwave, loading the three files specified by the configuration file, and then starts a custom “ACTIVE-X” control that processes the incoming digital commands from the insert/coordinating server 200 arriving in the audio stream and passed directly to the “ACTIVE-X” control by the Windows Media Player, which filters them out of the incoming audio stream and passes them on. The “Active-X” control manages the downloading of rich media ads from the rich ad sever 1700, as will be explained.

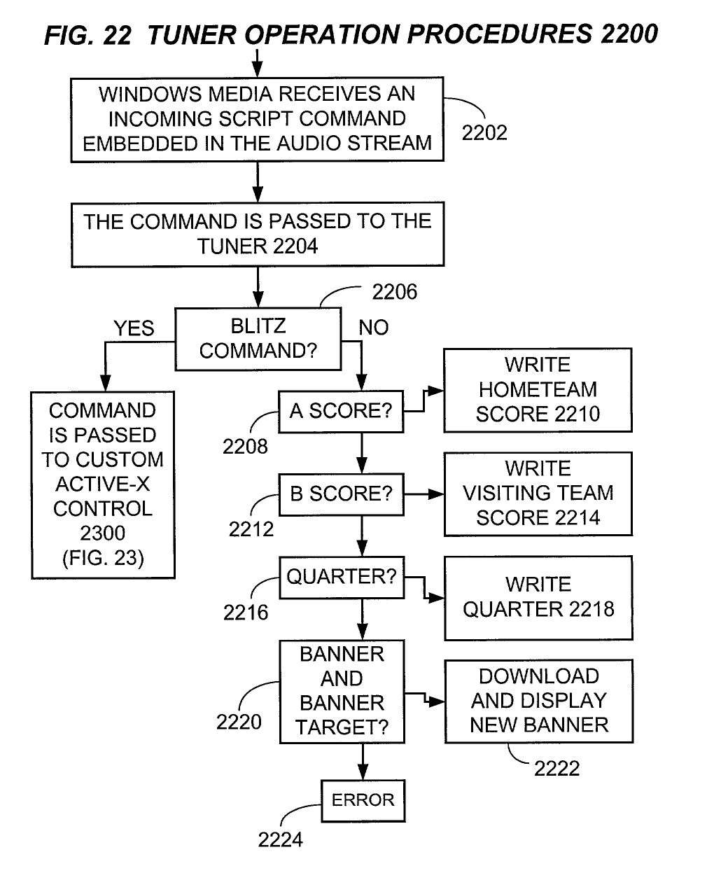

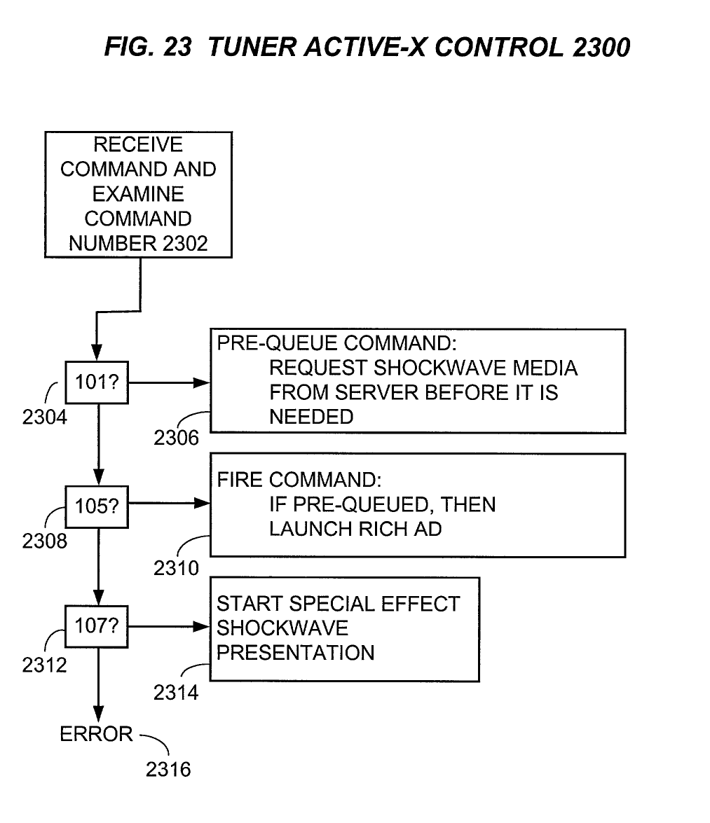

The incoming digital commands are processed as is shown in FIGS. 22 and 23. Windows Media receives the commands at step 2202 and passes them to the tuner 114 at 2204. The test at 2206 determines if the command is a “BLITZ” command. If not, then at steps 2208, 2212, 2216, and 2220 the command is tested to see what command it was, as shown in FIG. 22. The A and B SCORE commands from the producer system 700 cause the home team (step 2210) or the visiting team (step 2214) score to be updated, while the QUARTER command causes the quarter information to be updated (step 2218). The BANNER and BANNERTGT commands respectively cause a new banner graphic to be displayed and cause a new banner home page address to be selected (step 2222). And an error results if the command is unrecognizable (step 2224).

If the command is a “BLITZ” command, then step 2300 passes the command to the custom Active-X control, the details of which are shown in FIG. 23. The command is received at step 2302 and tested at steps 2304, 2308, and 2312, as is shown in FIG. 23. The “101” command is the pre-queuing command, which causes the Active-X control to request shockwave media from the rich ad server well ahead of time (step 2306). The “105” command launches such an ad in the window 7702, if it has been properly pre-queued. An instance of Shockwave is launched, given the window coordinates of the multimedia presentation within the tuner 110 window, and presented with the name of the shockwave presentation that was previously prequeued. This starts the multimedia advertisement presentation. The “107” command, provided by the producer system 700, initiates a special effect Shockwave presentation (flag waving, etc.). If the command is not recognized, this is an error condition (step 2316).

It is important, particularly with modems designed for use with ordinary telephone lines, and even more particularly with older and slower modems, to control the speed of the prequeuing downloading so that the downloading of the multimedia presentation, which must occur simultaneously with the incoming audio broadcast download, does not interfere with the live audio broadcast.

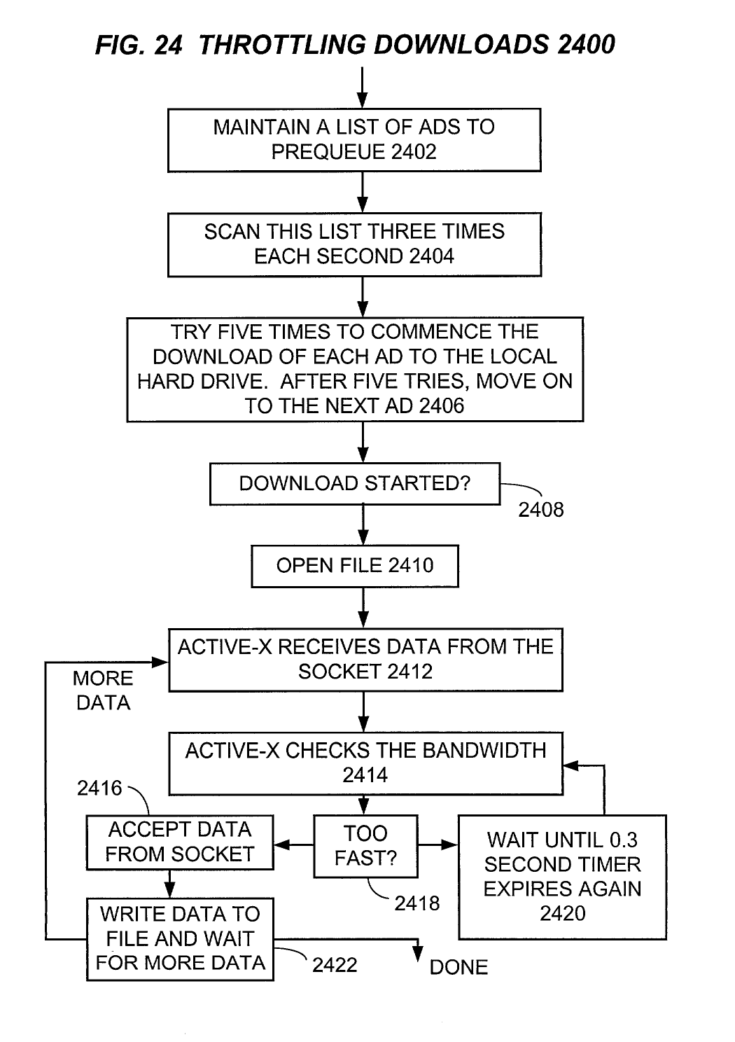

FIG. 24 illustrates at 2400 how this is done in the preferred embodiment of the invention. At step 2402, a list is maintained of all the advertisements which must be prequeued. At step 2404, this list is scanned three times each second. For each advertisement, the tuner 114 tries to commence the downloading of each ad to the local hard drive five times. If all five attempts fail, then the next advertisement is processed, and so on (step 2406).

At step 2408, if the download is actually started for an advertisement, then the file is opened (step 2410), and then the “Active-X control” begins to receive data from the socket (step 2412). Periodically, this “Active-X control” checks up on the bandwidth at which the data is flowing in (step 2414). If it is coming in too fast (step 2418), then the control waits for a 0.3 second timer to expire before returning to step 2424 to again check the incoming data bandwidth, and in the meanwhile new data is not accepted from the TCP/IP socket. But if the data flow is not too fast, then the control accepts new data from the TCP/IP socket (step 2416) and writes the data to a file (step 2422) and then awaits more incoming data, which is received from the socket again at step 2412. In this simple manner, by delaying the retrieval of data from the socket level of the layered interface to the Internet, the “Active-X control” throttles the flow of multimedia data back to an acceptable rate so as not to interfere, or block out, the incoming flow of audio data. This occurs because the TCP/IP socket refuses to permit more data to be sent until it has been emptied of data that has arrived earlier.

While the preferred embodiment of the invention has been described, numerous modifications and changes will occur to those skilled in the art to which the invention pertains. It is intended to encompass within the appended claims all such modifications and changes and alternative designs as fall within the true spirit and scope of the invention.

What is claimed as new and what is desired to be secured by Letters Patent of the United States is:

1. A network broadcasting system with provision for delivering broadcasts and also advertisements or other messages to individual users comprising:
a tuner software system designed to be installed within the computers of users who wish to receive broadcasts over the network and including a broadcast reception component that can receive a broadcast from the network and present it to the user;
a broadcasting system that broadcasts over the network to computers containing the tuner software system which have been enabled by their users to receive a broadcast;
a network signaling mechanism that signals over the network to computers containing the tuner software system and receiving a broadcast informing such computers of when advertisements or other information will appear within a broadcasts; and
a message presentation system associated with the tuner software system that responds to the signals by obtaining and presenting to the user an advertisement or other message simultaneously with, or as a replacement for, a portion of an incoming broadcast.

2. A networked computer broadcasting system in accordance with claim 1 in which the message presentation system includes
a multimedia advertisement or other message server containing advertisements or other messages;
an advertisement or message request component of said tuner software system that requests an advertisement or other message from said multimedia advertisement or other message server; and
the multimedia advertisement or other message server, in response to such a request, returns the requested advertisement or other message.

3. A networked computer broadcasting system in accordance with claim 2 wherein
at least some of the advertisements or other messages contained within the multimedia advertisement or other message server are associated with demographic information;
the multimedia advertisement or other message server also has access to demographic information of users and can associate that information with advertisement or other message requests received from the tuner software system of such users; and
when the multimedia advertisement or other message server receives a request for an advertisement or message which request can be associated with demographic information associated with a user and which request is for one of a set of advertisements or messages also associated with demographic information, the multimedia advertisement or other message server compares the two sets of demographic information and then returns to the requesting tuner software system those advertisements or other messages associated with demographic information most closely matched to the demographic information associated with the user.

4. A networked computer broadcasting system in accordance with claim 3 wherein the demographic information comprises the user's gender, age, and geographic location.

5. A networked computer broadcasting system in accordance with claim 4 wherein the geographic location for the user is specified as a zip code.

6. A networked computer broadcasting system in accordance with claim 5 wherein the multimedia advertisement or other message server is able to transform zip code information into region of the country information.

7. A networked broadcasting system in accordance with claim 1 wherein the broadcasting system receives commands from a producer system to have the tuner software systems present messages to the users, and wherein at least some of these commands cause the network signaling mechanism to signal the tuner software systems accordingly.

8. A networked broadcasting system in accordance with claim 7 wherein the producer system is connected by the network to the network signaling mechanism which is a stream encoder and wrapper which receives both the broadcast and also the producer commands and integrates them into a composite signal that is broadcast over the network to the user's computers.

9. A networked broadcasting system in accordance with claim 1 wherein the broadcasting system captures from the broadcast commands to have the tuner software systems present advertisements to the users, and wherein at least some of these commands cause the network signaling mechanism to signal the tuner software systems accordingly.

10. A networked computer broadcasting system in accordance with claim 9 wherein at least some of the commands captured from the broadcast are fed to the network signaling mechanism which is a stream encoder and wrapper which receives these commands and also the broadcast and integrates them into a composite signal that is broadcast over the network to the users' computers.

11. A networked broadcasting system in accordance with claim 9 which further includes
an insert and coordinating server into which said commands captured from the broadcast are fed and which also receives log files from a traffic system defining which advertisements are to be presented in what sequence during the broadcast, and
the insert and coordinating server adds to said commands captured from the broadcast specific advertisement identification information, thereby forming advertisement identifying commands which are then fed to the network signaling mechanism for transmission to the users' computers to cause the advertisements to be presented to the users.

12. A networked broadcasting system in accordance with claim 11 wherein the insert and coordinating server generates prequeue commands ahead of the time when an advertisement is to be presented to the user, the prequeue commands including the advertisement identification information; and
the insert and coordinating server sends the prequeue commands through the network signaling system to the tuner software systems to cause them to download advertisements ahead of when they are to be broadcast, and later generates fire commands which cause the tuner software systems to present the advertisements to the users at the proper times.

13. A networked broadcasting system in accordance with claim 1 wherein the broadcasting system receives commands from a producer system to have the tuner software systems present messages to the users and captures commands from the broadcast to have the tuner software systems present advertisements to the users, and wherein at least some of these commands cause the network signaling mechanism to signal the tuner software systems accordingly.

14. A networked broadcasting system in accordance with claim 13 wherein at least some of the commands received from the producer system and captured from the broadcast are fed into the network signaling mechanism which is a stream encoder and wrapper along with the broadcast, and the stream encoder and wrapper integrates them into a composite signal that is broadcast over the internet to the users' computers.

15. A networked broadcasting system in accordance with claim 13 which further includes
an insert and coordinating server into which said commands captured from the broadcast are fed and which also receives log files from a traffic system defining which advertisements are to be presented in what sequence during the broadcast, and
the insert and coordinating server adds to said commands captured from the broadcast specific advertisement identification information, thereby forming advertisement identifying commands which are then fed to the network signaling mechanism for transmission to the users' computers to cause the advertisements to be presented to the users.

16. A networked broadcasting system in accordance with claim 15 wherein the insert and coordinating server generates prequeue commands ahead of the time when an advertisement is to be presented to the user, the prequeue commands including the advertisement identification information; and
the insert and coordinating server sends the prequeue commands through the network signaling mechanism to the tuner software systems to cause them to download advertisements ahead of when they are to be broadcast, and later generates fire commands which cause the tuner software systems to present the advertisements to the users.

17. A networked broadcasting system in accordance with claim 16 wherein the insert and coordinating server also accepts producer commands from the network and forwards them to the network signaling mechanism.

18. A network broadcasting system with provision for delivering broadcasts and also advertisements or other messages to individual users comprising:
a tuner software system designed to be installed within the computers of users who wish to receive broadcasts over the network and including a broadcast reception component that can receive a broadcast from the network and present it to the user;
a broadcasting system that broadcasts over the network to computers containing the tuner software system which have been enabled by their users to receive a broadcast;
an advertisement or other message insertion system connecting to said broadcasting system that can replace portions of the broadcast or insert into the broadcast advertisements or other messages;
a network signaling mechanism that signals over the network to computers containing the tuner software system and receiving a broadcast informing such computers of when advertisements or other information will appear within a broadcasts; and
a message presentation system associated with the tuner software system that responds to the signals by obtaining and presenting to the user an advertisement or other message simultaneously with, or as a replacement for, an incoming broadcast.

19. A networked computer broadcasting system in accordance with claim 18 in which the message presentation system includes
a multimedia advertisement or other message server containing advertisements or other messages;
an advertisement or message request component of said tuner software system that requests an advertisement or other message from said multimedia advertisement or other message server; and
the multimedia advertisement or other message server, in response to such a request, returns the requested advertisement or other message.

20. A networked computer broadcasting system in accordance with claim 19 wherein
at least some of the advertisements or other messages contained within the multimedia advertisement or other message server are associated with demographic information;
the multimedia advertisement or other message server also has access to demographic information of users and can associate that information with advertisement or other message requests received from the tuner software system of such users;
when the multimedia advertisement or other message server receives a request for an advertisement or message which request can be associated with demographic information associated with a user and which request is for one of a set of advertisements or messages also associated with demographic information, the multimedia advertisement or other message server compares the two sets of demographic information and then returns to the requesting tuner software system those advertisements or other messages associated with demographic information most closely matched to the demographic information associated with the user.

21. A networked computer broadcasting system in accordance with claim 20 wherein the demographic information comprises the user's gender, age, and geographic location.

22. A networked computer broadcasting system in accordance with claim 21 wherein the geographic location for the user is specified as a zip code.

23. A networked computer broadcasting system in accordance with claim 22 wherein the multimedia advertisement or other message server is able to transform zip code information into region of the country information.

24. A networked broadcasting system in accordance with claim 18 wherein the broadcasting system receives commands from a producer system to have the tuner software systems present messages to the users, and wherein at least some of these commands cause the network signaling mechanism to signal the tuner software systems accordingly.

25. A networked broadcasting system in accordance with claim 24 wherein the producer system is connected by the network to the network signaling mechanism which is a stream encoder and wrapper which receives both the broadcast and also the producer commands and integrates them into a composite signal that is broadcast over the network to the user's computers.

26. A networked broadcasting system in accordance with claim 18 wherein the broadcasting system captures from the broadcast commands to have the tuner software systems present advertisements to the users, and wherein at least some of these commands cause the network signaling mechanism to signal the tuner software systems accordingly.

27. A networked computer broadcasting system in accordance with claim 26 wherein at least some of the commands captured from the broadcast are fed to the network signaling mechanism which is a stream encoder and wrapper which receives these commands and also the broadcast and integrates them into a composite signal that is broadcast over the network to the users' computers.

28. A networked broadcasting system in accordance with claim 26 which further includes
an insert and coordinating server into which said commands captured from the broadcast are fed and which also receives log files from a traffic system defining which advertisements are to be presented in what sequence during the broadcast, and
the insert and coordinating server adds to said commands captured from the broadcast specific advertisement identification information, thereby forming advertisement identifying commands which are then fed to the network signaling mechanism for transmission to the users' computers to cause the advertisements to be presented to the users.

29. A networked broadcasting system in accordance with claim 28 wherein the insert and coordinating server generates prequeue commands ahead of the time when an advertisement is to be presented to the user, the prequeue commands including advertisement identification information; and
the insert and coordinating server sends the prequeue commands through the network signaling system to the tuner software systems to cause them to download advertisements ahead of when they are to be broadcast, and later generates fire commands which cause the tuner software systems to present the advertisements to the users.

30. A networked broadcasting system in accordance with claim 18 wherein the broadcasting system receives commands from a producer system to have the tuner software systems present messages to the users and captures commands from the broadcast to have the tuner software systems present advertisements to the users, and wherein at least some of these commands cause the network signaling mechanism to signal the tuner software systems accordingly.

31. A networked broadcasting system in accordance with claim 30 wherein at least some of the commands received from the producer system and captured from the broadcast are fed into the network signaling mechanism which is a stream encoder and wrapper along with the broadcast, and the stream encoder and wrapper integrates them into a composite signal that is broadcast over the internet to the users' computers.

32. A networked broadcasting system in accordance with claim 30 which further includes
an insert and coordinating server into which said commands captured from the broadcast are fed and which also receives log files from a traffic system defining which advertisements are to be presented in what sequence during the broadcast, and
the insert and coordinating server adds to said commands captured from the broadcast specific advertisement identification information, thereby forming advertisement identifying commands which are then fed to the network signaling mechanism for transmission to the users' computers to cause the advertisements to be presented to the users.

33. A networked broadcasting system in accordance with claim 32 wherein the insert and coordinating server generates prequeue commands ahead of the time when an advertisement is to be presented to the user, the prequeue commands including advertisement identification information; and
the insert and coordinating server sends the prequeue commands through the network signaling mechanism to the tuner software systems to cause them to download advertisements ahead of when they are to be broadcast, and later generates fire commands which cause the tuner software systems to present the advertisements to the users.

34. A networked broadcasting system in accordance with claim 33 wherein the insert and coordinating server also accepts producer commands from the network and forwards them to the network signaling mechanism.

35. A networked computer broadcasting system with provision for delivering broadcasts and also advertisements or other messages to individual users, said system comprising:
a tuner software system designed to be installed within the computers of users who wish to receive broadcasts over the network and including a broadcast reception component that can receive a broadcast from the network and present it to the user and an advertisement or other message presentation component that can, in response to incoming network commands, display multimedia programs in place of, or simultaneously with, an incoming broadcast;
a broadcasting system that broadcasts over the network to computers containing the tuner software system which have been enabled by their users to receive a broadcast, including a mechanism for sending network commands to the tuner software systems signaling when the timer systems are to present multimedia presentations which correspond to advertisements or other messages to the users;
a producer system designed to be operated by a producer with a command generation system that permits a producer to originate, and present to the network, commands calling for various multimedia presentations including advertisements and other messages; and
an advertisement and other message insertion system connected to the network that receives the producer commands and sends them on to the computers of users who are receiving the corresponding broadcast, whereby the producer controls the presentation of advertisements and other messages to the user.

36. A networked computer broadcasting system in accordance with claim 35 wherein
the tuner software system includes a provision for displaying and thereby presenting a score or other number relevant to a broadcast to a user, and
the producer system includes a score or other number entry system that permits a score or other number to be entered into the producer system, transferred across the network to the insertion system, and transferred from there to the tuner software systems.

37. A networked computer broadcasting system in accordance with claim 35 wherein
the tuner software system includes a provision for displaying and thereby presenting a scrolled text message to a user, and
the producer system includes a keyboard or touch screen or speech recognition system that enables the producer to enter, review, and then transfer across the network a text message which is transferred across the network to the insertion system, and transferred from there to the tuner software system, where the message is presented scrollably to a user.

38. A networked computer broadcasting system in accordance with claim 35 wherein
the tuner software system includes a mechanism for accessing prerecorded multimedia messages relating to a broadcast, and
the producer system includes message presentation controls which, when actuated by the producer, cause commands to be sent over the network to the insertion system, and from there to the tuner software systems, which command the tuner software systems to present designated ones of those prerecorded multimedia messages to the users.

39. A networked computer broadcasting system in accordance with claim 35 herein
the producer system includes advertisement presentation controls which, when actuated by the producer, can command the display of advertising messages and which can prevent or postpone the display of advertising messages by the tuner software systems, these commands being conveyed over the network to the insertion system and from there to the tuner software systems.

40. A networked computer broadcasting system in accordance with claim 35 wherein the producer's computer is a hand-held computer wirelessly connected into the network.

41. A networked computer broadcasting system in accordance with claim 40 wherein
the tuner software system includes a provision for displaying and thereby presenting a score or other number relevant to a broadcast to a user, and
the producer system includes a score or other number entry system that permits a score or other number to be entered into the producer system, transferred across the network to the insertion system, and transferred from there to the tuner software systems.

42. A networked computer broadcasting system in accordance with claim 40 wherein
the tuner software system includes a provision for displaying and thereby presenting a scrolled text message to a user, and
the producer system includes a text entry system that enables the producer to enter, review, and then transfer across the network a text message which is transferred across the network to the insertion system, and transferred from there to the tuner software system, where the message is presented scrollably to a user.

43. A networked computer broadcasting system in accordance with claim 40 wherein
the tuner software system includes a mechanism for accessing prerecorded multimedia messages relating to a broadcast, and
the producer system includes controls which, when actuated by the producer, cause commands to be sent over the network to the insertion system, and from there to the tuner software systems, which command the tuner software systems to present designated ones of those prerecorded multimedia messages to the users.

44. A networked computer broadcasting system in accordance with claim 40 wherein
the producer system includes controls which, when actuated by the producer, can command the display of advertising messages and which can prevent or postpone the display of advertising messages by the tuner software systems, these commands being conveyed over the network to the insertion system and from there to the tuner software systems.

45. A networked computer system in accordance with claim 35 and used for broadcasting live or prerecorded sports events under the control of a producer, wherein
the producer system includes controls which, when actuated by the producer, can command the display of scores, multimedia messages, and text messages and can also cause the presentation of advertisements and delay the presentation of advertisements, said commands being conveyed over the network to the insertion system and from there to the tuner software systems; and
wherein the tuner software system includes provision for displaying to the user on a computer screen scores, multimedia messages, and text messages, as well as advertisements to the users.

46. A networked computer system in accordance with claim 45 wherein the tuner software system has two modes of display to the user, one mode filling a large portion of the user's screen, and a second mode occupying only a small portion of the user's screen, and where either screen display includes provision for displaying scores and text messages, and where advertisements and multimedia messages are presented in pop-up windows in conjunction with the second mode of display.

47. A network radio broadcasting system with provision for delivering broadcasts and also advertisements or other messages to individual users comprising:
a tuner software system designed to be installed within the computers of users who wish to receive broadcasts over the network and including a broadcast reception component that can receive a broadcast from the network and present it to the user and also an advertisement or other message insertion component that can download a multimedia advertisement or other message from a server and present it to the user simultaneously with or as a replacement for an incoming radio broadcast;
a broadcasting system that broadcasts over the network to computers containing the tuner software system which have been enabled by their users to receive a broadcast;
an advertisement or other message insertion system connecting to said broadcasting system that can replace portions of the broadcast with advertisements or other messages;
a network signaling mechanism that signals over the network to computers containing the tuner software system and receiving a broadcast informing such computers in advance of when multimedia advertisements or other information is to be presented to the user, and that also signals when those advertisements or other information are to be presented;
a mechanism within said tuner software system that can respond to said in advance signaling by downloading in advance of presentation multimedia advertisements or other messages at a controlled rate of downloading which does not interfere with reception of the broadcast and that can also respond to said presentation signaling by presenting the advertisements or other information at the proper time.

48. A networked computer broadcasting system in accordance with claim 47 wherein, as an advertisement or other message is downloaded, the system measures the bandwidth occupied by the download process, compares that to the network sustainable bandwidth and the bandwidth required by the broadcast, and then throttles back the advertisement or other message download rate as needed to insure that the message downloading process does not adversely affect the broadcast process.

49. A networked computer broadcasting system in accordance with claim 48 wherein incoming multimedia data is received from a TCP/IP socket, and wherein the throttling back of the incoming data is accomplished by delaying the acceptance of data from the TCP/IP socket.

50. A networked computer broadcasting system in accordance with claim 47 wherein the tuner software system includes provision for managing multiple simultaneous requests for the downloading of advertisements or other messages, the system maintaining a list of all such advertisements or other messages and their network addresses, the system periodically reviewing the list seeking an advertisement or other message that the network reports can be downloaded, and the system initiating the downloading of the advertisements or other messages sequentially.

51. A networked computer broadcasting system in accordance with claim 50 wherein, as an advertisement or other message is downloaded, the system measures the bandwidth occupied by the download process, compares that to the network sustainable bandwidth and the bandwidth required by the broadcast, and then throttles back the advertisement or other message download rate as needed to insure that the message downloading process does not adversely affect the broadcast process.

52. A networked computer broadcasting system in accordance with claim 51 wherein incoming multimedia data is received from a TCP/IP socket, and wherein the throttling back of the incoming data is accomplished by delaying the acceptance of data from the TCP/IP socket.

53. A networked computer broadcasting system in accordance with claim 47 wherein, in cases where a given tuner software system is unable to download fully an advertisement or other message prior to the time when the presentation signal indicates it should be displayed to the user, the tuner software system cancels the presentation of the advertisement or other message to the user and permits the user to receive the broadcast material instead.

54. A networked computer broadcasting system in accordance with claim 53 wherein the broadcasting system inserts advertisements into the broadcast at times when the tuner software system displays advertisements such that if a given tuner cancels a multimedia presentation of an advertisement, the user is still presented with the advertisement inserted into the broadcast.

55. A networked computer broadcasting system optimized for the reception of sports and other similar live and prerecorded broadcasts comprising:
a source of a live or prerecorded broadcast including commands from the source of the broadcast indicating appropriate places where advertisements or other messages may be inserted into the broadcast;
a producer system generating producer commands calling for the addition of scores and other textual messages as well as multimedia messages to a broadcast, and including provision for requesting the inclusion of advertisements in a broadcast or the prevention of the inclusion of advertisements in a broadcast;
a traffic system designed to facilitate the automated presentation and sale of multiple advertising opportunities to advertisers in packages that may be broken down by position of the advertisement within a broadcast (pregame, play-by-play, or postgame, etc.), by specific broadcast series, by specific group of broadcast series, and by range of dates as well as by number of advertising opportunity of a particular type, used in varying combinations in accordance with the needs and desires of the advertisers; the traffic system generating logs defining which advertisements are to be inserted into which portions of each broadcast in what order, and said logs, together with performance data gathered during each broadcast, being later used for billing purposes;
a tuner software system designed to be installed within the computers of users who wish to receive broadcasts over the network and including a broadcast reception component that can receive a broadcast from the network and present it to the user, a message presentation system that can selectively present advertisements and other multimedia messages to the user in response to commands, downloading such messages when necessary from a server ahead of time in response to prequeue commands, and presenting at least some of them at times indicated by fire commands, and a producer information presentation system that can present scores and other text messages as well as multimedia messages to the user in response to the receipt of producer commands, all such commands being conveyed to the tuner software system along with the broadcast; and
a broadcasting system that broadcasts over the network to computers containing the tuner software system which have been enabled by their users to receive a broadcast, including an insertion system that inserts advertisements or other messages into a broadcast and that also inserts the commands conveyed by the broadcast to the tuner software system, such insertions and commands originating from a coordinating system that is controlled by commands received from the source of the broadcast and from the producer system and that extracts from the logs the identification of the advertisements or other messages inserted by the insertion system or command to be presented by the tuner system.
